(19) United States
(12) Patent Application Publication
(10) Pub. No.: US 2025/0384644 A1
(43) Pub. Date: Dec. 18, 2025

(54) DIGITAL COMMUNICATION OF DENTAL ORAL HEALTH

(71) Applicant: 3SHAPE A/S, Copenhagen K (DK)

(72) Inventors: Admir HUSEINI, Copenhagen K (DK); Asger STOUSTRUP, Copenhagen K (DK); Aleksandar CEBOV, Copenhagen K (DK); Maria MERCANO, Copenhagen K (DK); Daniella ALALOUF, Copenhagen K (DK)

(73) Assignee: 3SHAPE A/S, Copenhagen K (DK)

(21) Appl. No.: 19/112,087

(22) PCT Filed: Sep. 13, 2023
(86) PCT No.: PCT/EP2023/075121

§ 371 Date: Mar. 14, 2025

(30) Foreign Application Priority Data
Sep. 14, 2022 (EP) 22195663.4

(51) Int. Cl. G06T 19/20; G06T 11/20; G06T 15/20

(52) U.S. Cl. CPC G06T 19/20; G06T 11/203; G06T 15/20; G06T 2200/24; G06T 2210/41; G06T 2219/2004; G06T 2219/2016

(57) ABSTRACT

Disclosed is a computer implemented method for rendering interactive digital three-dimensional dental models of a patient in a graphical user interface, wherein the graphical user interface is configured with communication tools providing effective, clear and understandable communication to the patient being examined.

### FIELD

The disclosure relates to computer implemented methods and systems utilized for rendering interactive digital three-dimensional dental models of a patient in a digital environment. The methods described herein provide effective digital communication and annotation tools that can be used by a dental practitioner to communicate dental and oral health findings in a clear, efficiently, and illustrative manner to a patient and which allow a dental practitioner to acquire previous knowledge of a dental arch of a patient acquired at for example two different points in time.

### BACKGROUND

Digital dentistry is becoming increasingly popular and offers several advantages over non-digital techniques. Within digital dentistry it is possible to obtain 3D digital representations of an oral cavity of a patient, wherefrom a potential change or changes of the oral cavity may be assessed over time by for example comparing two models acquired at two different points in time. Assessment of changes in a patient's oral cavity over time may be done manually by a dental practitioner for example from assessing a 3D representation of the oral cavity obtained by a dental scanning system and methods using intraoral scanners or data therefrom, such as scan data and/or stored data records, therefore. The data may be input to a variety of software solutions, such as patient monitoring systems, oral health assessment systems or similar, developed to automatically track changes over time between at least two digital 3D representations of an oral cavity obtained at two different points in time. Such systems may also be configured to detect at a single dental visit, dental health issues occurring in the oral cavity of the patient. Digital dentistry thus offers solutions for a practitioner to easily assess changes in a patient's oral cavity over time and to decide on any suitable treatment of the patient. However, for a patient to fully comprehend and understand the assessment of their oral cavity performed by the dental practitioner, over time or even at a first visit, it is highly relevant that the dental practitioner can communicate in an easy explanatory and visual manner to the patient what findings and subsequent treatments etc. that the dental practitioner suggests to the patient in view of the assessment of the oral health. Further, it is highly relevant that the dental practitioner can keep track of previous sessions and potential agreements made with the patient in view of the assessment. None such efficient solutions exist at the moment, why there is a need for suitable communication tools, methods and systems allowing a dentist to communicate efficiently, clearly and illustratively to a patient and which allow a dental practitioner to access previous knowledge of an oral cavity of a patient acquired at two different points in time.

### SUMMARY

The present disclosure addresses the above-mentioned challenges by providing a computer implemented method for rendering interactive digital three-dimensional dental models of a patient in a graphical user interface, wherein the method may comprise generating in the graphical user interface a digital space comprising at least one user interaction element and rendering in the digital space at least a first 3D digital model comprising dental information of a patient. To provide an efficient communication tool in connection with the rendered digital representation of the 3D digital mode, the method may furthermore comprise generating and superimposing a 2D digital canvas onto at least a part of the digital space including the first 3D digital model and receiving a user input trough the graphical user interface comprising executing an altering of the size of the digital space and/or a relative position of the digital space and the 2D digital canvas and applying a 2D transformation to one or more illustrative user inputs on the 2D digital canvas depending on the size and/or change in relative position of the digital space and 2D digital canvas.

The digital space may be construed as a 2D scene in the graphical user interface. This 2D scene may undergo different altering due to e.g. a change in positioning of user elements, change in size of the display window (i.e. change in 2D scene size) or a change in the arrangement of the 3D model in the view area. Accordingly, the digital space may be construed to comprise the 2D scene and a rendered 3D model in a view area of the digital space. Accordingly, a change in the digital space described herein may be a change that affects both the 2D scene and the 3D model rendering in a view area of the digital space. As a result of the change caused by the altering, a relative position between the elements (i.e user interaction elements of the 2D scene and the 3D model rendering) of the digital space may change in relation to the generated 2D digital canvas. To ensure that the relative change between the digital space (comprising the 2D scene with user interaction elements and the 3D model) and the 2D digital canvas is accounted for in respect to where the illustrative user inputs have been applied to the 3D model rendering, the method provides for applying a 2D transformation to one or more illustrative user inputs on the 2D digital canvas. In this way, any change that happens to the 2D scene or 3D model may affect the 2D digital canvas generated as the 2D digital canvas and its illustrative user inputs is transformed in accordance with the changes. In other words, a transformation may be applied to the 2D digital canvas ensuring that the illustrative user inputs of the 2D digital canvas follows at least the changes made to the 3D model.

In other words, the method described herein comprises:
generating in the graphical user interface a digital space configured as a 2D scene and comprising at least one user interaction element arranged in the 2D scene;
rendering in a 3D viewing area of the 2D scene at least a first 3D digital model comprising dental information of a patient, wherein the rendering is configured as a projection of the 3D digital model in the 2D scene;
generating and superimposing a 2D digital canvas onto at least a part of the 3D viewing area of the 2D scene including the first 3D digital model;
generating, based on a received user input to the graphical user interface, one or more alterations of the 2D scene or the 3D digital model, wherein the one or more alterations comprises one or more of:
   a change in a position of the at least one user interaction element in the 2D scene;
   a change in size of the 2D scene;
   a change in arrangement of the 3D digital model in the view area;
updating the arrangement of the 3D digital model in the view area based on one or more of the alterations, wherein each update generates a change parameter, and
calculating a 2D transformation, wherein the 2D transformation comprises at least one change parameter acquired from the updated arrangement, and
applying the 2D transformation to one or more illustrative user inputs on the 2D digital canvas.

With such a solution, an efficient communication tool providing the dental practitioner with the possibility of annotating, drawing, writing etc. directly on the 3D model of a patient's oral cavity via the provision of a 2D digital canvas is provided. In this way, when a dental practitioner is to communicate an assessment of a patient's oral health to the patient, the dental practitioner may easily draw, write and/or annotate directly onto the digital 3D model representing the oral cavity of the patient. In this way the practitioner can easily communicate any finding to the patient without having to manually write notes on a separate paper or similar. Furthermore, with this method, the practitioner may also move the 3D digital model around in the digital space, whereby any illustrative user input (i.e., drawing, annotation, writing) that has been made to the 3D digital model via the 2D digital canvas will follow the movement of the 3D model. Furthermore, by using this method also a change in the digital space in general (i.e. the digital space comprising both the 3D model and one or more user action element), such as a zoom, change in graphical user interface setup with one or more user interaction elements changing position, being added etc. may be followed up by a digital transformation ensuring that the illustrative user input to the 2D digital canvas always follows the 3D digital model. In this way, the illustrative user inputs will always stay in place at the origin on the 3D digital model, where they were initially applied by the practitioner independently from which position, orientation, scaling etc. that the digital space with the 3D digital may be in.

As previously mentioned, it should be noted that the “digital space” as described herein may be construed as a 2D scene of a graphical user interface, such as a display window, in which a 3D model may be projected onto. That is, the 3D model may be projected onto the 2D scene using a 3D viewport (also denoted a view area) rendering the projection of the 3D model to the 2D scene. An alteration of the 2D scene or the 3D model may in accordance with the method described herein cause an update of the 2D scene in relation to the update performed to the 3D model or the other way around. Any of such alteration may affect the 2D digital canvas which preferably should follow the change to at least the 3D model rendering, why a 2D transformation is calculated to account for the relative change between updates to the 3D model and the 2D digital canvas.

That is, the method described herein may further be configured such that in response to a user input through the graphical user interface, the method is configured for executing a change in position, rotation, zoom or size of the 3D digital model and executing simultaneously with said change in position, rotation, zoom or size of the 3D digital model, said 2D transformation to one or more illustrative user inputs on the 2D digital canvas. In this way it is ensured that any change to the 3D model in the digital space will also result in a corresponding change to the illustrative user input on the 2D digital canvas ensuring that the user of the software (in which the methods is implemented) experience that the user input follows the 3D model without any delays happening when an adjustment to the 3D model or digital space is happening.

In more detail, the method may comprise extracting the change parameter generated based on the execution and calculating the simultaneously with the change in position, rotation, zoom or size of the 3D digital model the 2D transformation comprising the extracted change parameter and applying the 2D transformation to the one or more illustrative user inputs on the 2D digital canvas.

It should be noted that the methods described herein may be related to a dental scanning system elaborated on throughout the disclosure, and the method may further comprise loading into a computer of the dental scanning system, scan data taken from a patient during an intraoral scanning. Accordingly, the rendering of at least a first 3D digital model into the digital display may be based on scan data taken from scan data loaded into the computer of the dental scanning system. The scan data may also form part of a patient record stored in the software of the system described herein. Accordingly, scan data may be understood as data gathered during a scan session and subsequently rendered into a 3D model illustrated in a display. Scan data as recorded during a scan session may also be stored in a data record, from where the scan data can be loaded into the system and rendering into a 3D digital model illustrated on a display.

To apply the one or more illustrative user inputs to the 3D digital model via the 2D digital canvas, the one or more illustrative user inputs are applied to the 2D digital canvas from at least one user interaction element of the graphical user interface. That is, the graphical user interface may comprise one or more user interaction elements that are configured to be activated by e.g., a dental practitioner by e.g., a click of a mouse or a touch of a finger to the display of a computer system where the graphical user interface is displayed. Accordingly, when a user activates a user interaction element on the graphical user interface, a 2D digital canvas may be enabled in the digital space of the graphical user interface, at least at the space of the digital space occupied by the 3D digital model.

The activated 2D digital canvas allows for one or more illustrative user inputs to be applied to the 3D model via the 2D digital canvas, e.g., the one or more illustrative user inputs applied to the 2D digital canvas may be configured as a digital hand drawing drawn onto the 2D digital canvas from user inputs applied to at least one user interaction element. Furthermore, the illustrative user inputs may also be annotations, written text or any other suitable input that can be applied in a digital manner by using a computer mouse or a touch screen input.

To refine the illustrative user inputs to resemble a non-digital hand drawing or written text, the one or more illustrative user inputs may be post processed by applying regularization and smoothing operation to the one or more illustrative user inputs. In this way, any illustrative user input made to the 3D digital model via the 2D digital canvas resembles an actual hand drawing or text as if it was done on a regular piece of paper. The raw user input from the mouse or touchpad comprises a plurality of sudden changes and irregularities in the form of the raw user inputs. To ensure that the raw user input look less unnatural the mentioned post-processing in form of regularization and smoothing is applied. In addition to providing the regularization and smoothing, a further post-processing may be applied to the raw input from the mouse or touchpad ensuring that the user input looks like a hand-written font or making the arrows straight as if they were recognized to be arrow shapes. This automatic change to the raw user input helps the dentist focus on the communication and not on his input to the 2D digital canvas.

Often, a dental practitioner, when assessing a scanned oral cavity, is interested in illustrating to the patient specific areas of interest of the oral cavity that need further attention in view of treatment or potential prevention of further development of any dental condition.

Therefore, it may be relevant for the dental practitioner to be able to flag (by use of e.g., annotations, drawings, writing etc.) specific areas of interest, which with the disclosed method can be facilitated in that the illustrative user inputs applied to the 2D digital canvas may be transformed onto the 3D digital model at areas of interest of the 3D digital model as defined by a user. In this way the dental practitioner may be able to identify areas of interest by providing illustrative user inputs to 3D digital model via the 2D digital canvas. These illustrative user inputs may be transformed onto the 3D digital model at the specified areas of interest for evaluation purpose.

Examples of areas of interest on the 3D digital model may comprise areas with identified dental conditions, such as plaque, caries, gingivitis, gingival recession, tooth wear, cracks, malocclusion or any other possible condition that may be present in the oral cavity. Further, the marking of an area of interest via the illustrative user input applied to the 2D digital canvas and transformed into a point, points, an area or areas on the 3D model, could also in addition to the just described examples of dental conditions, be fillings, crowns or any other dental restorations which could be worth marking on the 3D model and consequently storing in relation the 3D digital model being evaluated.

Accordingly, the method may in an example be configured to connect an illustrative user input to specific areas on the 3D digital model. Such method may comprise detecting the form, shape or textural content of the illustrative user input (e.g., using shape recognition); identifying a first landmark forming part of the illustrative user input; identifying a second landmark forming part of an area of interest on the 3D digital model and translating the first landmark of the illustrative user input to the second landmark forming part of an area of interest on the 3D digital model. In this way the specific drawings provided onto the 2D digital canvas in the form of an illustrative user input may be snapped to a specific area of interest (as given by a landmark) on e.g., a specific tooth, a plurality of teeth, areas of interest of e.g., the gingiva etc.

The first landmark forming part of the illustrative user input could for example be one of a e.g., the center of a circular form, a rectangular form or any other shape drawn onto the 2D digital canvas or e.g., a tip or end of an arrow, a line, a spline or any other geometrical line-shape having two ends.

The second landmark forming part of the 3D digital model could for example be one of e.g., an area of the gingiva of interest, a single tooth, an area with e.g., caries, plaque, gingival recession, gingival margin, tooth wear or any other possible area of interest related to e.g a dental condition or restorations etc.

Further in addition to the just described features, the method may be configured to allow one or more illustrative user inputs to be snapped to areas of interest on the 3D digital model, whereas other illustrative user inputs may be configured as illustrative user inputs free of snapping to the model. That is, in an example the method solutions described herein may be configured with a “snap-to-model” application module, which when activated by a user by e.g. pressing a virtual button in the graphical user interface activates the method described herein to further perform the method of identifying a first landmark forming part of the illustrative user input; identifying a second landmark forming part of an area of interest on the 3D digital model translating the first landmark of the illustrative user input to the second landmark forming part of an area of interest on the 3D digital model. In this way the specific drawings provided onto the 2D digital canvas in the form of an illustrative user input may be snapped to a specific area of interest (as given by a landmark) on e.g., a specific tooth, a plurality of teeth, areas of interest of e.g., the gingiva etc., as previously described.

In one example, when the “snap-to-model” application module is activated, the method may be configured to detect, by e.g., using shape recognition, an arrow, circle, line, spline or other geometrical shape drawn to the 2D digital canvas as an illustrative user input. When the shape of the illustrative user input has been recognized a measure of a center of e.g., a circle, tip of a line or arrow, or center of mass or any other geometrical measure forming a landmark point of the illustrative user is identified. To translate the landmark point of the illustrative user input into the 3D digital model, then landmark of the area of interest to which the illustrative user input should be connected is identified. In an example this area of interest landmark (i.e., the second landmark) could comprise identification of the centers of e.g., the gingiva, single tooth, area with caries, area with tooth wear etc. When the “snap-to-model” application is activated, the method may be configured to identify e.g., the tooth center (forming the second landmark) closets to the geometrical measure forming a landmark point of the first landmark (such as the circle center, tip of arrow etc. of the illustrative user input) and then to translate the geometrical measure forming a landmark point of the first landmark to the second landmark point. In this way the first landmark of the illustrative user input is translated onto the second landmark of the 3D digital model.

In an example one or more first landmarks of the illustrative user input may be translated into one ore more second landmarks of the 3D digital model. This may e.g., be the case where a gingival margin has been drawn onto the 3D digital model via an illustrative user input to the 2D digital canvas to reflect e.g., gingival recession. In this case a spline following the gingival margin of the patient could be drawn by a dental practitioner and one or more points of that spline could form the one or more first landmarks. Accordingly, when translating the one or more first landmarks onto the 3D digital model, one or more second landmarks, such as one second type landmark for each tooth in relation to the gingival margin of interest may be identified to allow the entire spline, drawn to represent the gingival margin, to be snapped onto the 3D digital model.

In another example, the area of interest could be a caries region, a gingivitis region, a plaque region, tooth wear region, cancer region, crack region etc. which may be identified by a dental practitioner by applying an arrow drawing to the 3D digital model via the 2D digital canvas. In such case, the first landmark could form the tip of the arrow, which may be translated into e.g., a second landmark being e.g., a tooth center of the tooth closets to the arrow of the tip.

In a further example, the areas of interest could be a caries region, a gingivitis region, a plaque region, tooth wear region, cancer region, crack region etc. which may be identified by a dental practitioner by applying a circular form drawing to the 3D digital model via the 2D digital canvas. In such case, the first landmark could form the center of the circular form drawing, which may be translated into e.g., a second landmark being e.g., a tooth center of the tooth closets to the center of the circular form drawing.

In case of the illustrative user input e.g., being virtual handwritten text, the method is configured to identify the text as input to the 2D digital canvas via e.g., text recognition algorithm, and to identify and lock the spatial position of the text on the 2D digital canvas. Further, to ensure that the text follow the 3D digital model without being rotated in space upon a change to the 3D digital model or a change to the digital space in general, the method comprises locking the spatial position in relation to the 3D digital model. In this way, any text that a dental practitioner may add to the 3D digital model via an input to the 2D digital canvas may stay in the spatial position at which it was entered, such that the text for example would not as a result of a change to the 3D digital model or the digital space will end upside down, vertical etc.

In addition to the already described examples, the method described herein may utilize one or more transformations to ensure that the illustrative user input follows a change in the digital space, and especially that any illustrative user input follows at least a change to the 3D digital model. That is, in more detail, when a user input is applied to the graphical user interface the digital space of the graphical user interface may be updated accordingly. A user input to e.g., one or more user interaction elements may result in a change of the visual layout of the graphical user interface, where user interaction elements may disappear or appear and/or further user interaction elements may be added in addition to already existent user interaction elements etc. Another user input could be a scaling, rotation or translation provided directly to the 3D model. Further, a possible user input is e.g., a zoom of the screen at which the graphical user interface is displayed. Accordingly, any change to the graphical user interface may cause a change to which the digital space comprising the 3D digital model which the illustrative user inputs should follow. Therefore, based on a user input to the graphical user interface the method may comprise updating the digital space, such as the view area of the digital space, by rescaling, rotating or translating the rendering of the 3D digital model; and further applying a 2D transformation to the illustrative user inputs to follow the change to the rendering of the 3D digital model. In this way it is ensured that any rescaling of the digital space results in a corresponding rescaling of the 3D digital model and at the same time a transformation to the illustrative user inputs ensuring that the illustrative user inputs follow the change in the 3D digital model.

The method may comprise extracting the change parameter correlated with the above mentioned rescaling, rotating or translating of the 3D model rendering, and subsequently updating the 2D transformation with the extracted change parameter, so as to applying the updated 2D transformation to the illustrative user inputs to follow the change to the rendering of the 3D digital model

As an example the user input may be configured to cause a change in a window size of the digital space, wherein updating the digital space comprises calculating a change in center position of the 3D digital model in relation to the 2D digital canvas as a result of the change in digital space and applying the calculated change to the illustrative user inputs of the 2D digital canvas into the changed position of the 3D digital model in the digital space. In more detail, the method may comprise updating the view area by translating and scaling the 3D model rendering in the view area in accordance with the change in window size. Subsequently calculating a change in center position of the 3D digital model based on the translation and scaling; and applying the calculated change to the illustrative user inputs of the 2D digital canvas so as to transform the 2D digital canvas into the changed position of the 3D digital model in the digital space.

In an example the user input may provide one of a scaling, rotation or translation to the digital space, which with the disclosed method results in updating the rendering of the 3D digital model and applying a corresponding 2D scaling, rotation or translation to one or more illustrative user inputs to follow the scaling, rotation or translation of the 3D digital model in the digital space. In this way it is ensured that any change made to the digital space of the graphical user interface, being either to the user interaction elements and/or directly to the 3D digital model, causes a corresponding change to the illustrative user inputs, ensuring that these will always follow the 3D digital model layout in the graphical user interface and does not move from the position on the 3D digital model where the illustrative user inputs were originally applied.

In one example the corresponding 2D scaling, rotation or translation is obtained by applying a virtual inverse perspective projection to the 2D points forming the illustrative user inputs, applying the corresponding 3D scaling, rotation or translation to the projected points and calculating a perspective transformation matrix using the obtained depth values. In more detail, the perspective transformation matrix may be calculated by extracting from the illustrative user inputs on the 2D digital canvas, depth values associated with each point of the illustrative user input, wherein the depth values represents a relation between the points of the illustrative user input of the 2D digital canvas and the 3D digital model to which the points have been applied. Subsequently calculating a perspective projection transformation matrix from the depth values and the scaling, rotation or translation associated with the 3D model changes; and applying the perspective projection transformation matrix to the 2D points forming the illustrative user inputs. In this way it is ensured that the each point associated with an illustrative user input is moved in correspondence with the changes applied to the 3D model in the digital space. This may be understood as a way of extracting the previously mentioned change parameter when a rotation, translation or rescaling is e.g. performed to the 3D model rendering.

When the dental practitioner has applied any illustrative user input to the 3D digital model via the 2D digital canvas it may be relevant for the dental practitioner to be able to assess those illustrative user inputs at a later point in time. Therefore, the method may be configured with of the storing in a storage medium, the illustrative user inputs applied to the 2D digital canvas to a plurality of different views of the 3D digital model at which the illustrative user input is applied. That is, in light of the 3D digital model being rotatable in the digital space, also the separate sets of illustrative user inputs may be applied to the 3D digital model at different camera views (i.e., virtual views) of the 3D digital model. Any illustrative user input applied to the 3D digital model via the canvas for a specific camera view may be stored in the storage media for that specific view of the 3D digital model. As an example, a dental practitioner may provide an illustrative user input to the 3D digital model at a first camera view, whereby the method automatically stores the illustrative user input at this first camera view. Subsequently, the dental practitioner may rotate the 3D digital model to a second camera view and apply a second illustrative user input to the 3D digital model at this second camera view, followed up by storing the illustrative user input to the second camera view. At a later point in time, the dental practitioner may with the method disclosed be able to assess any of the stored illustrative user inputs at respective views of the 3D digital model.

That is, the method may comprise loading from a storage medium a previously stored illustrative user input associated with a 3D digital model taken at a previous point in time; and rendering the 3D digital model in the digital space from the stored camera position; and superimposing the stored illustrative user input onto the 3D digital model.

To make it easy for the practitioner to identify relevant camera position having the associated illustrative user inputs, the graphical user interface may comprise a view management window comprising a plurality of camera positions representing the view position of the rendering of the 3D model and from which a user may activate a camera position. Accordingly, the method may comprise receiving a user interaction causing activation of one of the pluralities of camera position. When one of the pluralities of camera positions is activated by the user, the method may comprise: executing a rendering of the 3D digital model in the digital space (i.e. in the view area) from the chosen camera position and loading from the storage media one or more camera position associated 2D digital canvas comprising stored illustrative user inputs, into the view area at the position of the 3D model, where the illustrative user inputs have previously been stored.

To change between the different camera positions, the user may apply a user input to the view management window, which effectively allows a change between the camera positions. That is, a user may choose in the view management window a camera position, from where the 3D digital model should be illustrated in the digital display. Thus, a user input to a specific camera position in the user management window enables a rendering of the 3D digital model in the digital space form the chosen camera position. In addition, the stored illustrative user inputs associated with that specific camera position of the 3D digital model may also be illustrated in the digital space together with the 3D digital model.

In more detail, the method may comprise receiving a first user input to the view management window, wherein the user input represents an activation of a first of the one or more camara positions,
tracking a change from a first input to a second input to the view management window, wherein the second input represents an activation of a second of the one or more camera positions;
activating an updated rendering of the 3D model in the view area based on the tracked change, where the update comprises:
   updating the rendering from the first camera position to the second camera position; loading from the storage media a stored 2D digital canvas associated with the second camera position into the view area of the 3D model wherein the illustrative user inputs have previously been stored. With this, the user may be able to see any previously applied illustrative user inputs at the areas of the 3D model where the illustrative user inputs were originally stored.

Furthermore, the method may be configured such that one illustrative user input is independent from another user input. This may allow one or more user input to be drawn to the canvas without the user input forming any physical relation. Accordingly, the method may be configured such that upon receiving an input from a user via the graphical user input, the method may delete from the 2D digital canvas one or more previously drawn user inputs as chosen by a user via the received input to the application module.

Furthermore, the method may comprise the possibility of receiving a user input via the graphical user interface, wherein the user input causes the application module to update, modify or alter an already existing illustrative user input as a result of the received user input. In this way, the dental practitioner may be allowed to move, change or make any other suitable altering or modification to an already drawn illustrative user input. This may be applied for example when loading from a storage a saved illustrative user input, as e.g., described in relation to the view management window, and to potentially change, alter or modify that saved illustrative user input.

In an example, the method may be configured to load a previously stored illustrative user input of a previously generated 3D digital model, taken at a first point in time, and to transfer the previously stored illustrative user input onto a new 3D digital model, taken at a second point in time. In this way, a previously drawn user input can be compared with a new situation of the oral cavity, and potentially be modified to adapt to the new situation of the 3D digital model taken at a second point in time.

The methods and systems described herein may relate to providing dental information of an oral cavity of a patient, wherein the dental information data relating to at least one of tooth and/or gingiva of an oral cavity and wherein the dental information corresponds to a dental condition of the patient. The dental information may be understood as any of the herein described dental conditions, such as plaque, cracks, caries, tooth wear, gingivitis, gingival recession etc. and/or may include restorations, fillings or any other object that could form part of the oral cavity.

The 3D digital model may represent scan data acquired at a single point in time, e.g., a patient being scanned at a first dental visit. However, the 3D digital model disclosed herein may also be configured as a comparison 3D digital model comprising change information between a first 3D digital model taken at a first point in time and a second 3D digital model taken at a second point in time. In this way, the 3D digital model may comprise dental information from two scan data taken at two different points in time. When utilizing a 3D digital model configured as a comparison 3D digital model, this allows a dentist to assess changes in an oral cavity over time and potentially draw, write or annotate on the comparison model any changes in the oral cavity over time by using the illustrative user inputs. Thereby, the dental practitioner can in an easy and explanatory visual manner explain to a patient any areas of interest that have been identified as relevant in the patient's oral cavity over time. This could be a progressive state of a dental condition, such as the development of plaque, caries, bone loss, tooth wear, gingivitis, gingival recession etc. Furthermore, by being able to assess the oral cavity in a comparison view (i.e., two 3D digital models overlayed onto each other and representing two scan data taken at two different points in time), the dental practitioner may easily identify any oral health problem, associate any illustrative user inputs to the comparison 3D digital model and store the data for further use at a later point in time.

The methods described herein may be configured as application modules configured to be executed by a computer. Accordingly, the disclosure provides for a computer readable medium configured to store instructions that, when executed by a computer, cause the computer to perform a method of rendering interactive digital three-dimensional dental models of a patient into a graphical user interface, the method comprising:
generating in the graphical user interface a digital space comprising at least one user interaction element;
rendering in the digital space an at least a first 3D digital model comprising dental information of a patient;
generating and superimposing a 2D digital canvas onto at least a part of the digital space including the first 3D digital model;
based on a user input to the graphical user interface, changing the size of the digital space or the relative position of the digital space and the 2D digital canvas; and
simultaneously applying a 2D transformation to one or more illustrative user inputs on the 2D digital canvas depending on the change in relative position of the digital space and the 2D digital canvas. The computer readable medium may be configured to execute the methods as described herein and as will be further explained in the detailed description of the Figures. Further any advantageous and effects as described in relation to the method also applies.

In more details, the computer readable medium may be configured to store instructions that, when executed by a computer, performs a method of:
generating in the graphical user interface a digital space configured as a 2D scene and comprising at least one user interaction element;
rendering in a 3D viewing area of the 2D scene at least a first 3D digital model comprising dental information of a patient, wherein the rendering is configured as a projection of the 3D digital model in the 2D scene;
generating and superimposing a 2D digital canvas onto at least a part of the 3D viewing area of the 2D scene including the first 3D digital model;
   generating based on a received user input to the graphical user interface, one or more alterations of the 2D scene or the 3D digital model, wherein the or more alterations comprises one or more of: a change in position of the at least one user interaction element in the 2D scene;
   a change in size of the 2D scene;
   a change in arrangement of the 3D digital model in the view area;
updating the arrangement of the 3D digital model in the view area based on one or more of the alterations, wherein each update generates a change parameter, and;

calculating a 2D transformation, wherein the 2D transformation comprises at least one change parameter acquired from the updated arrangement; and applying the 2D transformation to one or more illustrative user inputs on the 2D digital canvas.

Furthermore, the disclosure provides for a computer program product embodied in a non-transitory computer readable medium comprising computer readable program code configured to be executed by a hardware processor to cause the hardware data processor to perform the methods disclosed herein when the computer readable program code is executed by the hardware data processor.

### BRIEF DESCRIPTION OF THE FIGURES

Examples as described herein may be best understood from the following detailed description taken in conjunction with the accompanying figures. The figures are schematic and simplified for clarity, and they just show details to improve the understanding of the claims, while other details are left out. Throughout, the same reference numerals are used for identical or corresponding parts. The individual features of each example described may each be combined with any or all features of the other examples unless stated otherwise. These and other examples, features and/or technical effect will be apparent from and elucidated with reference to the illustrations described hereinafter in which:

FIG. 1 illustrates a scanning system according to examples of the disclosure;

FIG. 2 illustrates a processing system of the dental scanning system according to examples of the disclosure;

FIG. 3 illustrates one or more method procedures performed by the processing system according to examples of the disclosure together with outputs to a graphical user interface from the method;

FIG. 4 illustrates application module elements in the graphical user interface together with the patient specific record and a rendered 3D model of scan data in the graphical user interface according to examples of the disclosure;

FIG. 5 illustrates an application module and sub-methods configured to be activated via the application module according to examples of the disclosure;

FIG. 6 illustrates a graphical user interface with illustrative user inputs applied thereto via a 2D digital canvas according to examples of the disclosure;

FIG. 7 illustrates the process of the method according to examples of the disclosure;

FIG. 7a illustrates the process upon activation of a user interaction element;

FIG. 8 illustrates a position of the graphical user interface with the 3D model and the illustrative user inputs prior to a change made to the graphical user interface by a user according to examples of the disclosure;

FIG. 9a illustrates a position of the graphical user interface with the 3D model and the illustrative user inputs after a change is made to the graphical user interface by a user according to examples of the disclosure;

FIG. 9b illustrates a position of the graphical user interface with the 3D model and the illustrative user inputs as corrected with the method in response to the change made to the graphical user interface by a user according to FIG. 9b;

FIG. 10a illustrates a position of the graphical user interface with the 3D model and the illustrative user inputs before a change is made to the graphical user interface by a user according to examples of the disclosure;

FIG. 10b illustrates the change in relation to FIG. 10a made to the graphical user interface by a user according to examples of the disclosure;

FIG. 10c illustrates the projection process of the illustrative user inputs via the 2D digital canvas to the 3D model in response to a change according to FIG. 10b;

FIG. 10d illustrates the resulting projection of the illustrative user inputs to the 3D model according to the process of FIG. 10c;

FIG. 11a illustrates a position of the 3D digital model prior to a change according to examples of the disclosure;

FIG. 11b illustrates a position of the 3D model of FIG. 11a after a rotation of the 3D model according to examples of the disclosure;

FIG. 11c illustrates a position of the 3D model of FIG. 11a after a zoom of the 3D model according to examples of the disclosure;

FIGS. 12a and 12b illustrates the virtual or inverse perspective projection according to the disclosure according to examples of the disclosure;

FIG. 13a illustrates a graphical user interface according to the disclosure further comprising a view management window according to examples of the disclosure;

FIG. 13b illustrates a graphical user according to the disclosure, where the view management window is illustrated in a mode of operation according to examples of the disclosure;

FIG. 13c illustrates a detailed version of the view management window according to FIG. 13a, where a tangent plane representing the 2D digital canvas for example camera views is illustrated;

FIG. 13d illustrates a detailed version of the view management window according to FIG. 13c, where the examples tangent planes, representing the 2D digital canvas, comprises a stored illustrative user input;

FIG. 13e illustrates a detailed version of the view management window according to FIG. 13d, wherein a specified camera view has been chosen and wherein the 2D digital canvas for that specific camera view is clearly showing the illustrative user input;

FIG. 14 illustrates a computer processor configured to perform methods of one or more application modules according to examples of the disclosure;

FIG. 15; illustrates plaque found when probing a tooth;

FIG. 16 illustrates development of caries in a tooth over time;

FIG. 17 illustrates a first class of tooth wear;

FIG. 18 illustrates a second class of tooth wear;

FIG. 19 illustrates a third class of tooth wear;

FIG. 20 illustrates a fourth class of tooth wear;

FIG. 21a illustrates a gingivitis example;

FIG. 21b illustrates gingivitis where bleeding is present;

FIG. 22 illustrates a flow of a first and second dental visit by a patient according to examples of the disclosure;

FIG. 23a illustrates an example of a first stage of a “snap-to-model” application;

FIG. 23b illustrates an example of a second stage of a “snap-to-model” application; and

FIG. 24 illustrates an example flow of a snap-to-model application model method.

### DETAILED DESCRIPTION

The detailed description set forth below in connection with the appended drawings is intended as a description of various examples according to the disclosure. The detailed description includes specific details for the purpose of providing a thorough understanding of various concepts and examples covered throughout the disclosure. However, it will be apparent to those skilled in the art that these concepts and examples may be practiced without the specific details mentioned or in combination with one or more examples described herein. Several examples of the devices, systems, media or mediums, programs and methods are described by various modules, components, steps, processes, algorithms, etc. Depending upon particular application, design constraints or other reasons, these elements may be implemented using electronic hardware, computer program, or any combination thereof. In the following several examples of the methods and system described herein will be disclosed in more detail.

### Effective Communication

As previously described, patients typically go through a routine dental checkup once a year or maybe with shorter time intervals. As part of such dental visits, patients may get scanned in a dental clinic using for example an intraoral scanner. Thus, scanning at these dental visits may generate one or more 3D data sets representing the dental situation of the patient oral cavity at the timepoint of acquisition of the data set. These historical data sets or a single scan acquisition may be utilized to detect, classify, predict, monitor etc. a potential development, or change in the dental situation over time when these data sets are compared directly or indirectly to one another. In an example, instructions that, when executed by a computer, cause the computer to load, visualize and analyze difference(s) between dental information in the form of 3D data obtained from the same patient at different timepoints in a digital 3D space. Such data may be in the form of 3D topology and geometrical data, complemented with one or more of color data, fluorescence data, infra-red data or any other type of data associated with the 3D topology of the dental situation.

An assessment of the dental data, either at a first session providing only one scan or using historical data sets utilized by one or more scans at different points in time may allow the dental practitioner to communicate to the patient any relevant finding to discuss with the patient and/or to store such communicative information (as provided by e.g., the illustrative user input described in the following) in a storage for later assessment. In order for the patient to fully comprehend and understand the information provided by the dental practitioner it is relevant for the dental practitioner to be able to easily visualize and explain to the patient what the findings are. With the method described herein it is ensured that the dental practitioner is able to assess the 3D digital model in a human-machine interaction process, where a user input to a digital display enables a computer program to perform a method of drawing onto a 3D digital model rendered in a digital display, but at the same time ensuring that the drawing (i.e. the illustrative user input) is locked to the position of the 3D digital model. This to store the illustrative user input for further assessment at a later time and/or to ensure that any change to the 3D digital model results (via a method) to a corresponding change to the illustrative user input.

Accordingly, exemplary methods of providing an effective communication and visualization tool will in the following be disclosed in more detail in connection with a computer implemented method for rendering interactive digital three-dimensional dental models of a patient. Furthermore, a computer readable media configured to execute the method as instructed by computer is also described in further detail together with a dental system utilized to gain scan data of the oral cavity of a patient.

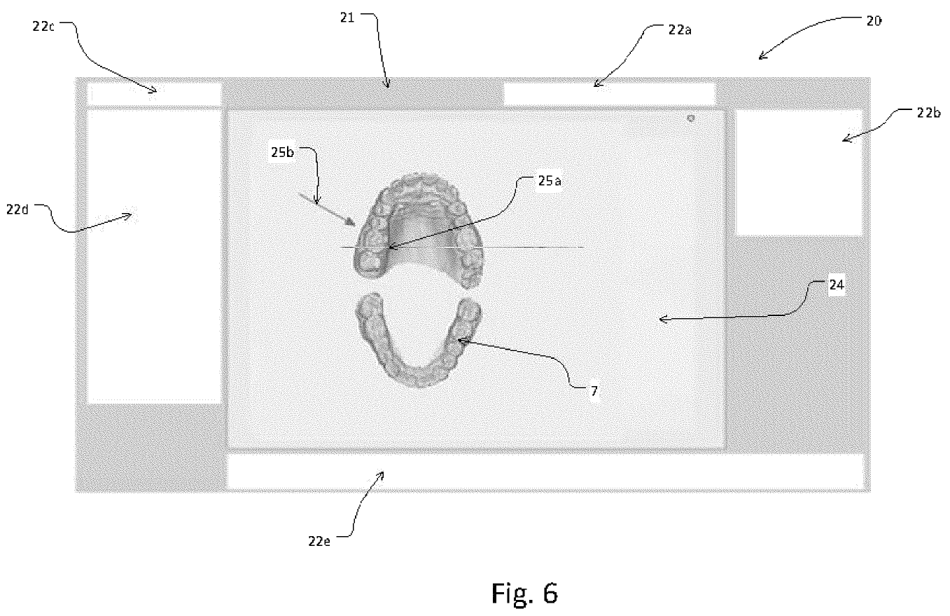

The dental practitioner may via a scanning system communicate with the patient by the utilization of a graphical user interface 20 as illustrated in an example in FIG. 6. Here, a graphical user interface 20 according to the method described herein is illustrated. The graphical user interface 20 comprises in an example embodiment of the method a rendered interactive 3D digital model 7, represented as a full jaw comprising an upper and a lower jaw. The full jaw representation shown in FIG. 6 is only one example of representing the 3D digital model described herein. The 3D digital model could also be represented as either a single lower or upper jaw and or as a “bite” stage of the upper and lower jaw. In any case, the 3D digital model 7 is generated by generating in the graphical user interface a digital space 21 comprising at least one user interaction element 22a (several user interaction elements 22a, 22b, 22c, 22d, 22e is illustrated in FIG. 6). The 3D digital model 7, which may be a first 3D digital model, is rendered in the digital space 21 as at least a first 3D digital model, wherein the 3D digital model 7 comprises dental information of a patient. Accordingly, the 3D model may be construed as being rendered in a view area of the digital space. Furthermore, the method comprises generating and superimposing a 2D digital canvas 24 onto at least a part 21a (also denoted view area or viewport) of the digital space 21 including the first 3D digital model 7. The 2D digital canvas 24 may comprise an illustrative user input 25a which is applied to the 2D digital canvas 24 from a user input to the graphical user interface 20. That is, the method provides for adding illustrative user inputs 25a, 25b to the 2D digital canvas 24 in such a manner that the illustrative user inputs 25a, 25b are substantially visually applied to the 3D model 7. Accordingly, when a user intentionally makes a change to the graphical user interface 20 (i.e. either to the 3D model or a change in the 2D scene), the method is configured to, receive a user input through the graphical user interface 20, and based on the received user input executing an altering of the size of the digital space 21 and/or a relative position of the digital space 21 and the 2D digital canvas 24 and applying a 2D transformation to one or more illustrative user inputs 25a, 25b on the 2D digital canvas 24 depending on the size and/or change in relative position of the digital space 21 and 2D digital canvas 24. As previously mentioned, the altering may be any change in positioning of elements in the digital space (i.e. 2D scene), such as the user interaction element or the 3D model of the view area. The altering may cause a relative change between e.g., the 2D scene and the 3D model which causes a relative change between the 3D model and the illustrative user inputs applied to the 2D digital canvas.

In addition to the above-described method, the change to the illustrative user input as a reaction to the execution of the altering in the digital space may happen at least simultaneously and in synchrony with an execution of an altering of the 3D digital model in the digital space. That is, according to examples described herein, when a user input through the graphical user interface is received, the method is configured for executing a change in position, rotation, zoom or size of the 3D digital model and executing simultaneously with said change in position, rotation, zoom or size of the 3D digital model, said 2D transformation to one or more illustrative user inputs on the 2D digital canvas. In this way it is ensured that a synchronized and simultaneous change is happening to the 3D digital model and the illustrative user input, ensuring that the illustrative user inputs stay in place at the position where it was originally entered (e.g., drawn) on the 2D digital canvas.

The dental information includes information which can be collected from the 3D digital model of a dental arch of a patient. The 3D digital model 7 may comprise a dental arch of a patient, which is the curved oral structure made of the alveolar process, teeth, and the supporting soft tissues (gingiva) (including the teeth in a jaw). Further the 3D digital model may comprise the superior arch, also denoted the upper jaw, and the inferior arch also denoted the lower jaw, where generally, the upper arch is bigger and wider than lower arch.

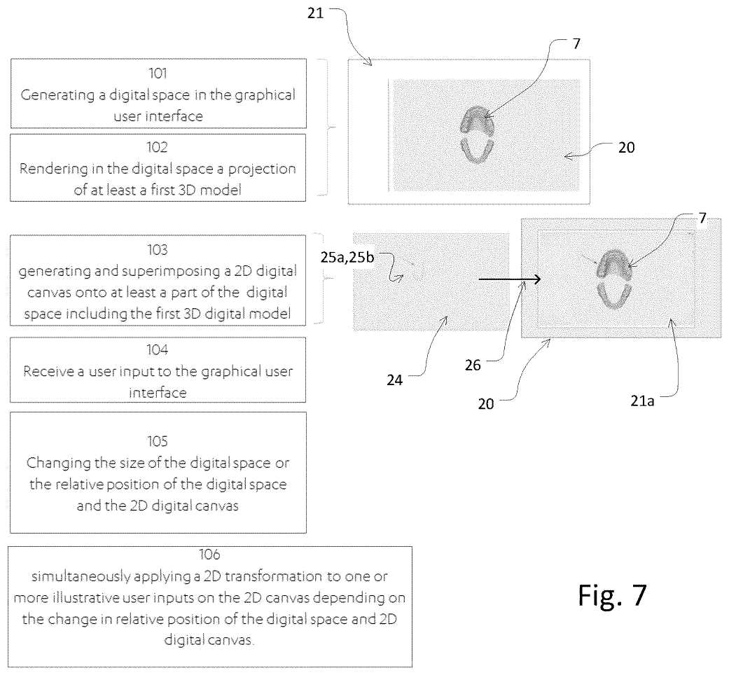

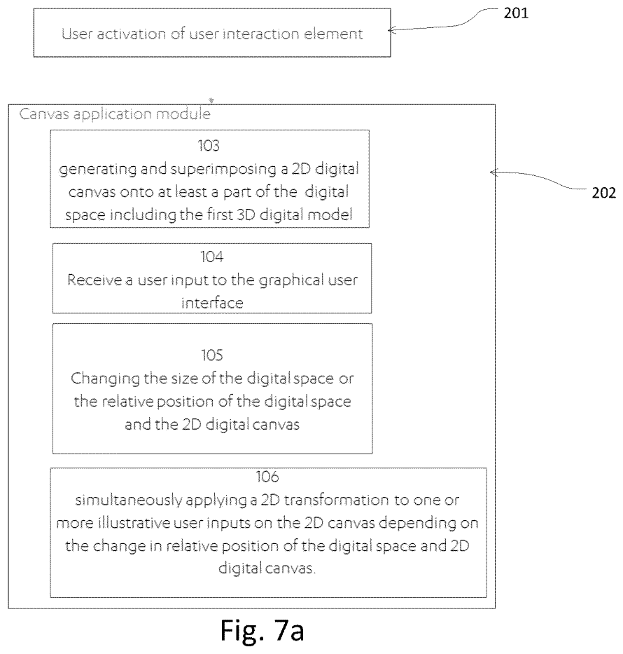

The method is illustrated more clearly in FIG. 7, where it is seen that in 101 a digital space is generated in the graphical user interface 20, wherein in the digital space 21 the method in 102 is configured for rendering at least a first 3D digital model 7. In 101 and 102 of FIG. 7, the corresponding graphical representation of the method is illustrated in the right part of FIG. 7, where a graphical user interface 20 corresponding to that of FIG. 6 is illustrated without any user interaction element(s), but merely with the representation of the rendered 3D digital model 7 in a digital space, this for facilitating the understanding of the method described herein.

The method comprises, as illustrated in 103 of FIG. 7, the generating a 2D digital canvas 24, which as illustrated by the arrow 26 in the right of FIG. 7 is superimposed onto at least a part of the digital space 21 of the graphical user 20 interface and comprising at least the 3D digital model 7.

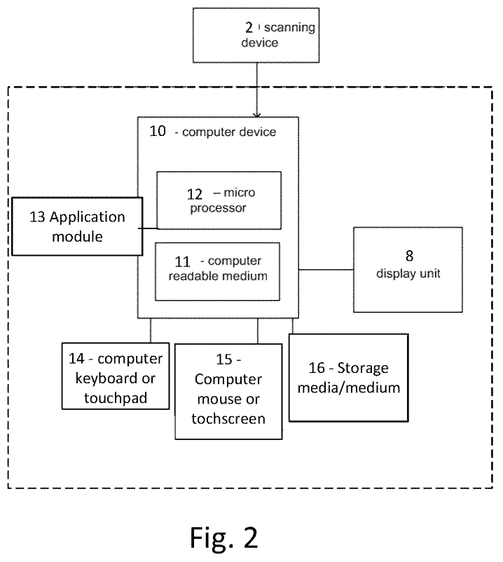

For activating the generation of the 2D digital canvas 24, a user interaction element 22 (could be any of user interaction element 22a, 22b, 22c, 22D, 22e) may be activated by a user such as by pressing a virtual button (forming the user interaction element), for example by the use of computer mouse or e.g., a touch pad as discussed in more detail in relation to FIG. 2 in sections described herein. The activation of the user interaction element, for example illustrated by user interaction element 22a (any of user interaction element 22a, 22b, 22c, 22d, 22e could be used as examples) results in the activation of an application module 202, as illustrated in FIG. 7a. Application module 202 may be configured to perform the method as described herein in relation to the 2D digital canvas. For facilitating understanding of the method, application module 202 related to the method described herein will in the following be denoted as a canvas application module. The canvas application module 202 may as an example be activated by for example a user interaction element configured as a virtual button represented by a e.g. a pencil or any other suitable symbol or object in the graphical user interface 20. That is, the activation of the user interaction element, as illustrated in FIG. 7a as an example user interaction element 201 (corresponding to any of user interaction elements 22a, 22b, 22c, 22d, 22e represented in the Figures) results in the canvas application module 202 being activated to at least perform the process 103 according to FIG. 7 of generating a 2D digital canvas 24 superimposed onto the 3D digital model 7. The 2D digital canvas 24 may comprise an illustrative user input 25, which have been applied to the 2D digital canvas 24 upon activation of the 2D digital canvas application module 202. In other words, one or more illustrative user inputs 25a, 25b is applied to the 2D digital canvas 24 from at least one user interaction element 22, 201 of the graphical user interfaces, which activates the canvas application module to perform the method described herein.

As illustrated in e.g., FIG. 6, the one or more illustrative user inputs 25a, 25b applied to the 2D digital canvas 24 is configured as a digital hand drawing drawn onto the 2D digital canvas 24 from user inputs applied to at least one user interaction element 22a, 22b, 22c, 22d, 22e (that is e.g., the virtual button as previously described). The canvas application module 202 as activated from the virtual button for example provided as a pencil, may further activate sub-modules of the graphical user interface. Upon activation of a sub-module the graphical user interface may be equipped with a corresponding user interaction element for the user to engage with by pressing the virtual button generated in the graphical user interface for that specific element. As an example, the activation of the canvas application module could result in the generation of further virtual buttons indicating a e.g., a color of the pencil to be used, an eraser configured erase the drawing, annotations etc. applied to the 2D digital canvas.

Each of the one or more illustrative user inputs applied to the 2D digital canvas may be post processed by applying at least one of a regularization and smoothing operation to the one or more illustrative user inputs. In this way the user input such as strokes made to the 2D digital canvas by the user from the use of a computer mouse or a touchpad may be processed to resemble a regular hand drawing or written text. As previously explained, the raw data of the one or more illustrative user inputs may be of very low quality and might distract the dentist in view of focusing on the illustrative user input rather than the relevant focus, namely the 3D drawing to which the illustrative user input should be associated. Therefore, the raw user input from a mouse or touchpad forming the illustrative user input is post-processed to remove the potential sudden changes and irregularities in the form, that makes it look unnatural if no post-processing in form of regularization and smoothing is applied. Furthermore, to make it more real-life looking, the post-processing also ensures that the illustrative user input looks like a hand-written font and/or that for examples drawn arrows becomes straight as if they were recognized to be arrow shapes. This helps the dentist focus on the communication and not on his input to the canvas.

Referring now back to FIG. 7 and FIG. 7a, the method comprises receiving 104 a user input to the graphical user interface. This user input to the graphical user interface can be any of an input applied directly to the 3D digital model or applied to any user interaction element of the graphical user interface. The user input 104 applied to the graphical user interface causes the method to changing 105 the size of the digital space or the relative position of the digital space and the 2D digital canvas. When a change in the digital space is present it is important that the illustrative user inputs 25a applied to the digital space 21 follows any change made to the 3D digital model 7 to ensure that the drawing, text or annotation made stays in the origin of the 3D digital model 7 where it was originally applied. Accordingly, as illustrated in 106 of FIG. 7, the method is configured to applying a 2D transformation to one or more illustrative user inputs 25 on the 2D digital canvas 24 depending on the size and/or change in relative position of the digital space 21 and 2D digital canvas 24. In this way it is ensured that the illustrative user input 25a, 25b applied to the 2D digital canvas 24 follows any movement of the 3D digital model 7 that may be caused by a change 104 in the digital space. As previously described the applying of a 2D transformation to one or more illustrative user input may be performed as an execution of the method happening simultaneously with the executing of the change to the 3D digital model.

Providing the same example as previously elaborated on, the activation of the user interaction element (provided in examples as any one of user interaction elements 22a, 22b, 22c, 22d, 22e) results in the activation of the canvas application module 202. The canvas application module 202 is then configured to perform the method described in relation to FIG. 7 and FIG. 7a, i.e., 103 and 104, and may further be configured to perform the process 106 of applying a 2D transformation to the one or more illustrative user inputs to allow them to be “locked” to a corresponding movement of the 3D model 7. Accordingly, when talking about a user input to the graphical user interface, this may be understood as a user input activating e.g., a user interaction element, such as a virtual push button (e.g., activating the canvas application module) or it may be an activation of any other user interaction element. In another example, the user input may also be applied directly to the 3D digital space, where the 3D digital model is represented. In any case, the canvas application module 202 will be activated when a change in the digital space happens to ensure that the illustrative user input follows the 3D digital model.

As is apparent from the description, different types of changes to the digital space may activate 105 and 106 (illustrated in FIG. 7 and FIG. 7a) according to the method.

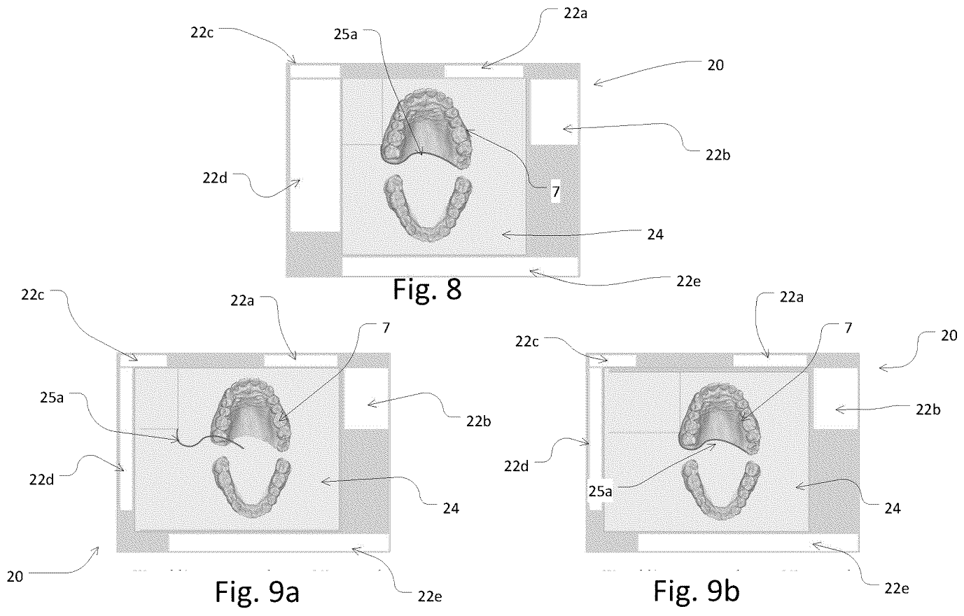

In one example illustrated in FIG. 8, FIG. 9a and FIG. 9b, the method as disclosed herein may react to a user input to the graphical user interface causing a re-arrangement of one or more of the user interaction elements 22a, 22b, 22c, 22d, 22e. That is, as illustrated in FIG. 8, a first setup of the user interaction elements 22a, 22b, 22c, 22d, 22e, illustrated together with the digital space 21 comprising the 2D digital canvas 24 and the rendered 3D digital model 7. In case of a re-arrangement by the addition, removal or change in position of the user interaction elements 22a, 22b, 22c, 22d, 22e in the digital space 21, the relationship between the 2D digital canvas and the 3D digital model may change as illustrated in FIG. 9a in comparison to FIG. 8. When comparing FIG. 9a with FIG. 8 it is seen that a change has been made to the position of the user interaction element 22e, which has caused a change to the part of the digital space 21 containing the 3D digital model 7. As seen in FIG. 9a in comparison to FIG. 8, the re-arrangement of the user interaction elements 22e causes a change to the digital space 21 and the 3D digital model 7, which the 2D digital canvas 24 with the illustrative user input 25a should follow in order to provide the correct visualization of where the dental practitioner drew the illustrative user input 25a. As can be seen from FIG. 9a the change, if not acquired for by the method provided herein causes the illustrative user input 25a to be displayed in the graphical user interface 20 at a wrong position in relation to the 3D model at which it was supposed to be visualized upon. Therefore, according to the method, upon a change caused by a re-arrangement of the user interaction elements in the digital space 21, the method is further configured for updating the digital space 21 by rescaling the rendering of the 3D digital model 7; and further applying a 2D transformation to the illustrative user inputs 25 to follow the change to the rendering of the 3D digital model. The update of the digital space 21 by rescaling the rendering of the 3D digital model 7 is illustrated in FIG. 9b, where it is seen that the digital space 21 has changed in comparison to the digital space 21 of FIG. 8 and where it is seen that the illustrative user input 25a has stayed in place in relation to the 3D digital model 7. Thus, when comparing FIGS. 9a and 9b it can be seen that the illustrative user input 25a has been transferred into the correct position on the 3D digital model 7 as a result of the rescaling of the 3D digital model 7 caused by the re-arrangement of the user interaction elements.

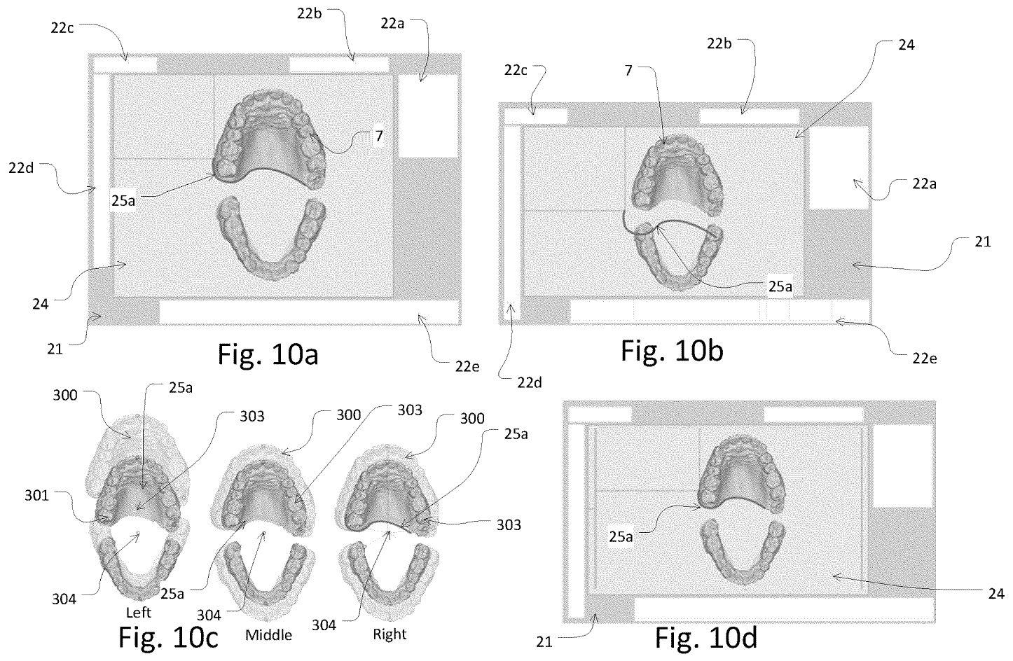

In another example, illustrated in FIGS. 10a to 10d the change in the digital space as caused by a user may also be configured as a change in size of the digital display. That is, the window size showing the digital display 21 on the computer may be changed by a user. To ensure that the illustrative user input in this case follows the corresponding change to the 2D digital canvas 24 and thereby the 3D digital model 7, the method is in one example configured to perform the method just described. That is, when for example the window size of the digital display changes as illustrated in FIG. 10a to FIG. 10b in a vertical direction the 3D digital model 7 may be rescaled as previously explained in relation to FIGS. 8 to 9a, 9b. Accordingly, when the window size is e.g. vertically changed as illustrated in the change between FIG. 10a and FIG. 10b, the method is configured to update the digital space 21 by rescaling the rendering of the 3D digital model 7. As previously described, this also triggers an update of the illustrative user input 25a of the 2D digital canvas 24 by applying a 2D transformation to the illustrative user inputs to follow the change to the rendering of the 3D digital model. The results of using the method as described herein in the current example can be seen in FIG. 10d, wherein it is clearly seen that the illustrative user input 25 has stayed in place in view of the 3D digital model 7. The 2D transformation applied to the 2D digital canvas may be based on the calculation of the relative translation and scaling of the point of origin of the 3D digital model in relation to the 2D digital canvas as illustrated in FIG. 10c. In more detail, when the window of the digital display 21 is vertically rescaled as just explained, the size of the 3D viewport (i.e., the digital space 21) is changed, which results in a downscaling of the rendering of the 3D model, as illustrated in FIG. 10c (Left). Here it is seen how the 3D digital model is rescaled from a first position 300 (shaded version of the 3D digital model) into a second position 301 (non-shaded overlay of the 3D digital model), because of the vertical rescaling of the digital space. With this rescaling also the relative centers of the old (i.e., first position 300) and new (i.e., second position 301) digital spaces have changed, which means that the rendering of the new 3D model has a translated center 304 relative to the old rendering having center 303. For this reason, in order to get the correct transformation between the first position 100 and the second position 301 of the 3D model, the method described herein ensures that, the old center (i.e., 303 in FIG. 10C) of the 3D model is translated into the new center (i.e., center 304 in FIG. 10c). Then the corresponding scaling centered on the translated center is applied, as illustrated in FIG. 10c (middle). As can be seen in FIG. 10c (right), the illustrative user input on the 2D digital canvas is then transformed according to the above-mentioned transformations, ensuring that the illustrative user inputs follow the changes occurring in connection with the 3D model.

It should be noted that the processes of the method, occurs in the background of the visual user interface (in a computer implementation), where the resulting transformations happening because of changes in the digital space is not directly visual to the user. Only the resulting movement of the illustrative user input as described herein can be visualized by a dental practitioner using the system and method. In other words, a user input causing a change in a window size of the digital space, activates the method described herein to perform an updating of the digital space by calculating a change in center position of the 3D digital model in relation to the 2D digital canvas as a result of the change in digital space and applying the calculated change to the illustrative user inputs of the 2D digital canvas into the changed position of the 3D digital model in the digital space.

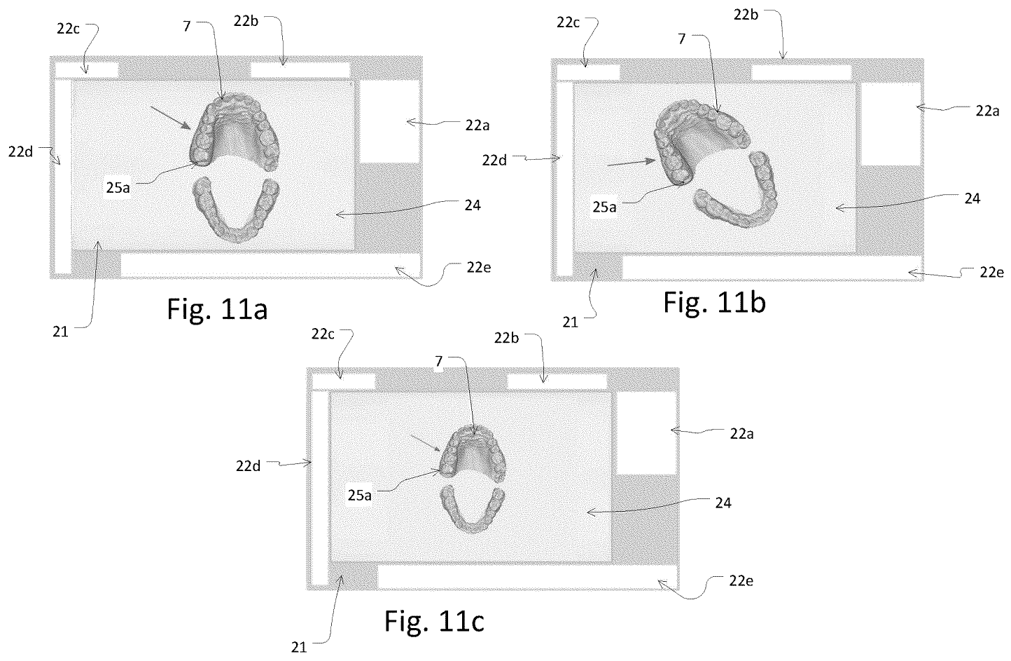

In a further example, illustrated in FIGS. 11a, 11b and 11c, the change in the digital space 21 comprising the 3D digital model 7 and the 2D digital canvas 24 with the illustrative user inputs 25a, may be caused by a user changing the orientation, such as scaling, rotating or translating the 3D digital model 7 in the digital space 21. In this case, the illustrative user inputs 25a should also follow the change to the 3D digital model 7. Accordingly, based on a user input providing one of a scaling, rotation or translation to the digital space updating the rendering of the 3D digital model 7, the method is further configured to applying a corresponding 2D scaling, rotation or translation to the one or more illustrative user inputs 25a to follow the scaling, rotation or translation of the 3D digital model 7 in the digital space. As an example, illustrated in FIG. 11a and FIG. 11b, the 3D digital model 7 may be rotated in the digital space as illustrated as the difference between FIG. 11a where the 3D digital model 7 is provided in a first stage and FIG. 11b where the 3D digital model 7 is provided in a second stage being rotated in comparison to FIG. 11a.

In a second example illustrated in FIGS. 11a and FIG. 11c, the 3D digital model may also undergo a scaling from a user input applied to the 3D digital model 7. This is illustrated as a comparison between FIG. 11a, where the 3D digital model 7 is in a first stage and FIG. 11c, where the 3D digital model 7 is in a third stage being a scaled version of FIG. 11a.

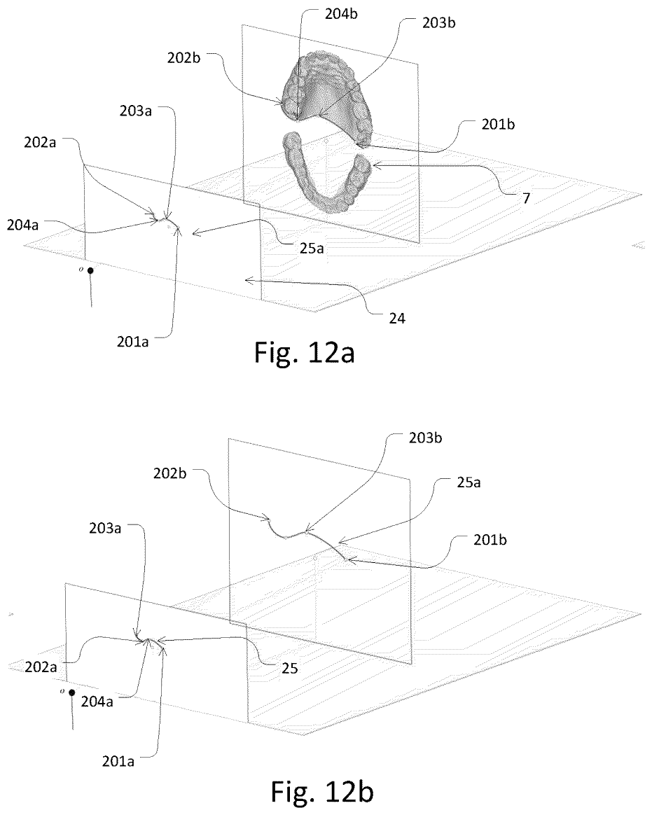

In the case of the user input being a scaling, rotation or translation of the 3D digital model as described in relation to FIGS. 11a to 11c, the method is configured to applying a corresponding 2D scaling, rotation or translations of the 2D digital canvas 24 in relation to the change to the 3D digital model 7, wherein the corresponding 2D scaling, rotation or translation is done by applying a virtual inverse perspective projection to the 2D points forming the illustrative user inputs, applying the corresponding 3D scaling, rotation or translation to the projected points and calculating a perspective transformation matrix using the obtained depth values. In accordance herewith, the method described herein comprises the calculation of an inverse perspective projection and applying the inverse perspective projection to the illustrative user inputs on the 2D digital canvas to map it onto the rendering of the 3D model. The 2D virtual inverse projection is illustrated in more detail in FIGS. 12a and 12b. Referring initially to FIGS. 12a and 12b, it is seen that all the points 201a, 202a, 203a, 204a of the illustrative user input 25a on the 2D digital canvas have the same z coordinates in relation to the 3D digital model to which they should be projected. That is, the 2D digital canvas 24 comprises the illustrative user input 25a, which comprises points 201a, 202a, 203a, 204a which are to be projected onto the 3D digital model in a z-direction resulting in a projection of the illustrative user input to points 201b, 202b, 203b, 204b illustrated in FIG. 12a. That is, using this value of z (depth) for each of the points of the illustrative user input, the inverse perspective projection values can be calculated as follows:

$${A}^{′} = ( \begin{matrix}{x}^{′} \\ {y}^{′} \\ 0 \\ 1\end{matrix} ) \to ( \begin{matrix}\frac{f + z}{f} \cdot x \\ \frac{f + z}{f} \cdot y \\ z \\ 1\end{matrix} ) = p ( {A}^{′} )$$

This provides a virtual projection mapping of the points of the illustrative user inputs to the 3D digital model as illustrated in the Figures. This is also illustrated in FIG. 12b, where the illustrative user input 25 is seen without the 3D digital model as a projection in depth, z. Accordingly, the method comprises the calculation of the depth values of each point of the illustrative user input to ensure that the points are correctly projected onto the 3D model.

In more detail the above defined geometric problem (i.e. the inverse projection) being solved ensures that the illustrative user inputs 25a follow a change in the 3D digital model and related changes to the 2D scene of the digital space. That is, given a camera C that projects the 3D scene (i.e., the 3D digital model) to a projection plane P (i.e. the view area of the 2D scene). One can choose a coordinate system, such that the plane P is the same as the xy-plane and the center F of the camera lies on the z axis at distance f from the xy-plane. In this case, all the 2D digital canvas points A′ (points 201a, 202a, 203a, 204a in FIGS. 12a and 12b) all lie at the xy-plane and have coordinates x′, y′ and z=0. If the center of the 3D digital model has distance z from the xy-plane, then it is possible to define a virtual plane V parallel to the xy-plane. By the given formula, it is then possible to calculate the inverse perspective projection p(A′) of the points A′ from P to the plane V. These points all lie on the plane V and if they are projected to the projection plane P, they would have coordinates x′, y′, 0. If the 3D digital model is transformed by a matrix M, then it is possible to apply the same matrix to the points p(A′) and project them to P. In this way it is ensured that a visual impression of the illustrative user input following a change to the 3D digital model is given.

The methods and systems described throughout the disclosure may as illustrated for example in FIG. 2 comprise a storage media/medium 16. In view of the disclosed method, the method comprises storing in the storage medium 16, the one or more illustrative user inputs 25a, 25b applied to the 2D digital canvas 21. The one or more illustrative user inputs 25a, 25b may be stored in the storage medium/media 16 in relation to a plurality of different views of the 3D digital model 7 at which the one or more illustrative user inputs 25a, 25b is applied. This creates the possibility for the dental practitioner to load into the computer system (also denoted computer device 2) the one or more illustrative user inputs 25a, 25b applied to patient specific scan data at a later stage in time in comparison to when the illustrative user inputs 25a, 25b was actually made to a 3D digital model 7 of the patient. Accordingly, the method described herein may in an exemplary embodiment comprise loading from a storage medium 16 a previously stored illustrative user input 25 associated with a 3D digital model 7 taken at a previous point in time; and rendering the 3D digital model 7 in the digital space 21 from the stored camera position; and superimposing the stored illustrative user input onto the 3D digital model.

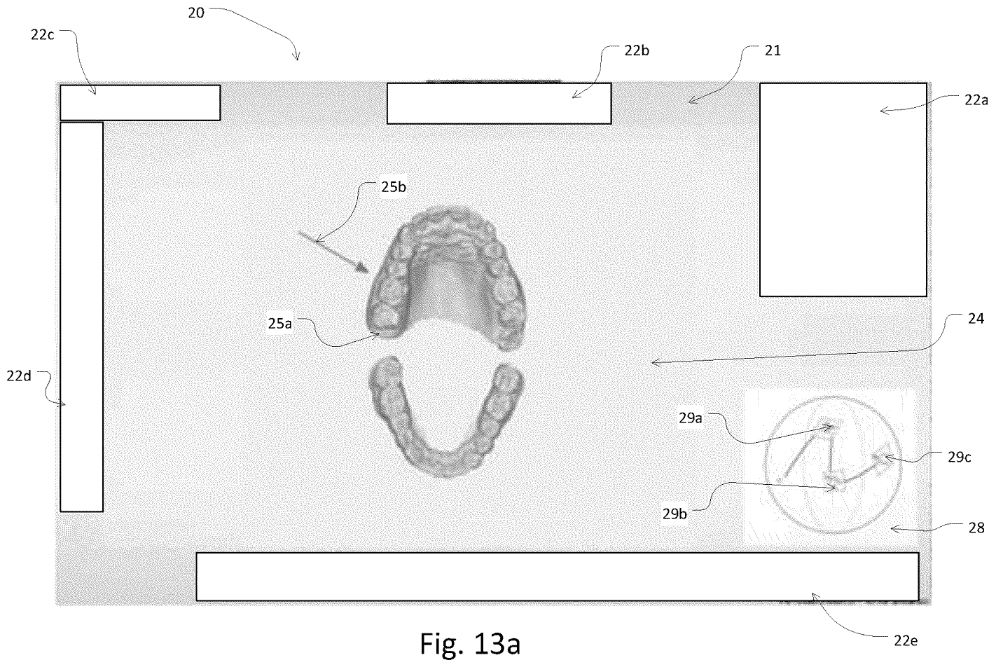

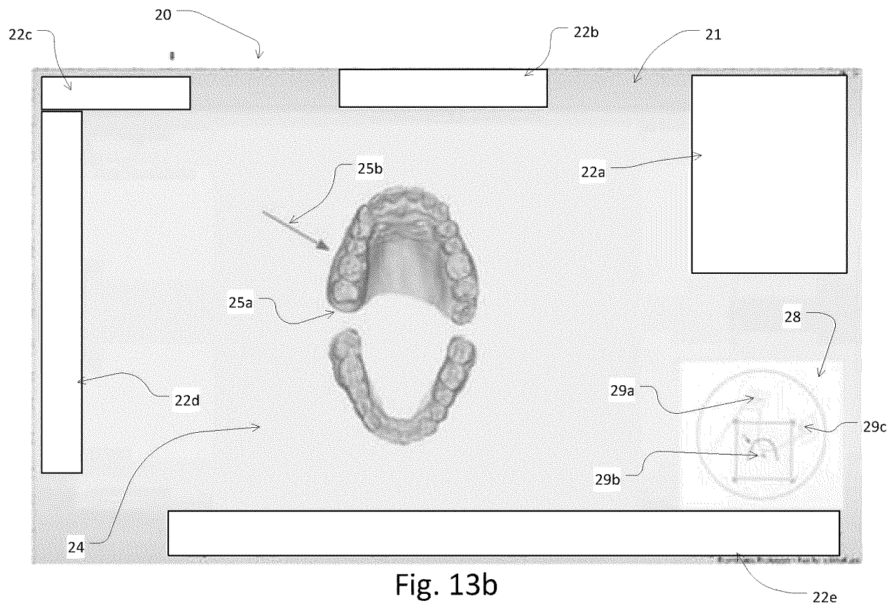

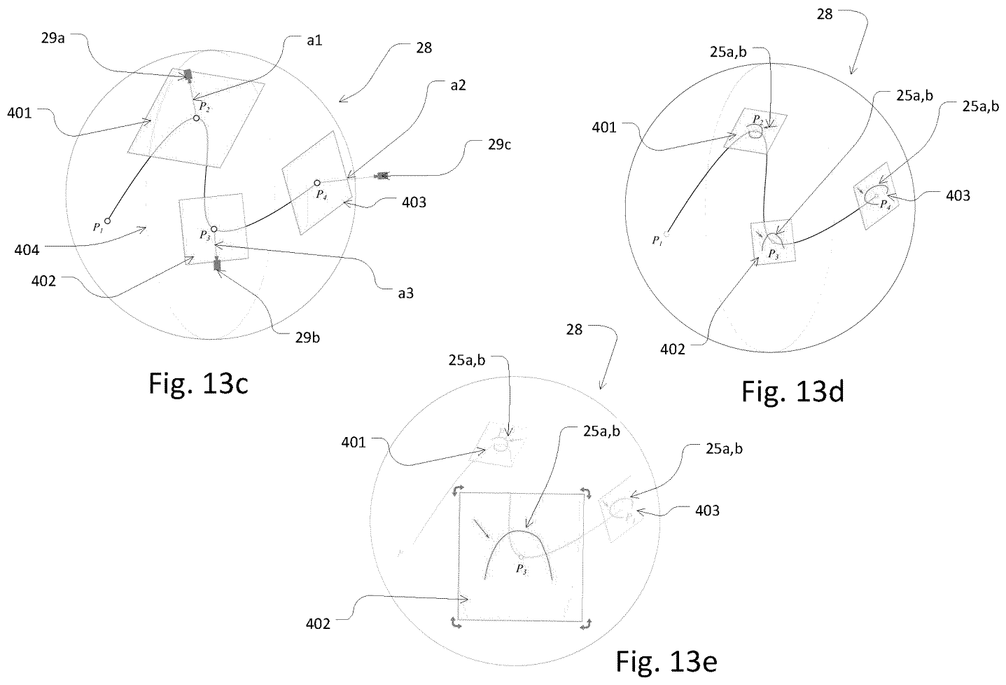

Turning now to FIGS. 13a and 13b, an example of utilizing the stored illustrative user inputs 25 in relation to a 3D digital model 7 will now be described. As illustrated in FIG. 13a and FIG. 13b the methods and systems described herein may comprise the possibility of loading into the computer system 10 and displaying in the graphical user interface 20 previously stored illustrative user inputs 25a,b wherein the previously stored illustrative user inputs 25a,b may be displayed at the position on the specific 3D digital model 7 at which they were originally applied. This provides the dental practitioner with the possibility of assessing illustrative user inputs applied to the 3D digital model of a patient at different points in time.

Accordingly, for the dental practitioner to manage the saved information of the illustrative user input, the disclosure in addition provides for a view management window 28 of the graphical user interface 20 which may be activated by the dental practitioner in order to assess previously saved illustrative user inputs 25a,b to a specific 3D digital model 7 of a patient. An example of such a view management window 28 is illustrated in FIG. 13a and FIG. 13b. Here it can be seen that the exemplary view management window 28 comprises a plurality of camera positions 29a, 29b, 29c representing the rendering of the 3D model 7 from different camera position, also denoted view areas. When a user activates one of the plurality of camera positions 29a, 29b, 29c, by e.g. pressing on user interaction elements representing the camera position in the graphical user interface, the method described herein is configured to rendering the 3D digital model 7 in the digital space 21 from the chosen camera position 29a, 29b, 29c and from the storage media 16 loading any associated 2D digital canvas 24, having illustrative user inputs 25a, 25b, such as annotations, writing, drawings and/or notes applied to the chosen camera position. Accordingly, upon receiving a user interaction causing activation of one or the plurality of camera positions, the method is configured to executing a rendering of the 3D digital model in the view area from the chosen camera position, and loading form the storage media an associated 2D digital canvas having illustrative user inputs applied thereto.

As previously described in relation to the user interaction elements activating the 2D digital canvas module, also in this case the view management window may be considered as a user interaction element. In this case the view management window, upon activation by a user (e.g., a virtual press on the view management window), activates an application module of the view management window configured to perform the above-described method. In this way a dental practitioner may load into the computer system one or more previously saved illustrative user inputs and the corresponding 3D digital models.

Furthermore, as it is possible for the dental practitioner to apply illustrative user inputs to the 3D digital model from different camera positions viewing the model form different angles (and activated by e.g. a rotation of the model by the dental practitioner) it is important that the stored illustrative user input is linked to camera position of the model at which the illustrative user inputs was applied, and subsequently saving to the storage media/medium the illustrative user input and the corresponding camera position.

An example of a view management window 28 providing different camera positions is illustrated in FIG. 13a. Here three camera positions 29a, 29b, 29c are illustrated together with the illustrative user inputs 25a, 25b made at the 3D digital model at each of the three camera positions. It should be noted that this is an example provided for illustrative purpose and other suitable view management window setups could be imaged.

FIG. 13b illustrates how in an example, the dental practitioner may choose one camera position 29b, from which the 3D digital model 7 is viewed and from which the associated illustrative user input 25a, 25b is loaded onto the 3D digital model 7. In this example the chosen camera position 29b is illustrated in the view management window 28 in a minimized version so as to allow the dental practitioner to keep track on the camera position 29b from which the dental practitioner chose to view the 3D digital model 7.

In a further example, the view management window 28 is configured to allow a change (such as by toggling by a user) between the camera positions 29a, 29b, 29c. This may be provided as a floating transition between the camera positions 29a, 29b, 29c, as a consequence of a user interaction by the dental practitioner to the view management window 28.

As disclosed herein the 3D digital model 7, may be represented as a comparison model comprising change information between a first 3D digital model taken at a first point in time and a second 3D digital model taken at a second point in time.

FIGS. 13c to 13e illustrates in more detail the view management window 28. The view management window may be considered as a “camera view exploration helper” or similar. The view management window 28 is configured such that a camera position, provided as examples of 3 virtual camera positions 29a, 29b, 29c, is defined by an axis a (illustrated by a1, a2 and a3 in the FIG. 13c) that defines the view direction and an angle omega that defines the amount of rotation around this axis. Each of the virtual camera positions 29a, 29b, 29c should be considered directly corresponding to the previous mentioned camera positions 29a, 29b and 29c in FIGS. 13a and 13b, and is provided as a visual representation of a camera for making the illustration clearer. To each of the camera positions 29a, 29b, 29c, a 2D digital canvas comprising stored illustrative user inputs is connected. The 2D digital canvas is represented as the tangent planes 401, 402, 403 to each of the respective camera positions 29a, 29b, 29c as illustrated in FIGS. 13a to 13b. In FIG. 13c none of the tangent planes 401, 402, 403 connected with a camera view comprises an illustrative user input. However, as soon as a dentist, or user of the method described herein, stores to a specified camera position 29a, 29b, 29c of the 3D digital model an illustrative user input 25a, 25b provided on the 2D digital canvas 24, it is possible from the view management window to easily retrieve the 2D digital canvas information, e.g. the illustrative canvas information 402, as illustrated in FIGS. 13d and 13e.

Accordingly, when a user clicks on any point on the sphere, representing a camera view 29a, 29b, 29c, it is via the method described herein possible to retrieve the view axis of the camera view and hence the corresponding camera position from where the corresponding dental data (i.e. the 3D digital model) should be rendered, possibly together with the illustrative user inputs that were applied to the digital model at that position. This is for example illustrated in FIG. 13d, where for example for camera position 29b, the illustrative user input 25a, 25b is present in connection with the 3D digital model obtained from that specific angle on the circle of the view management window. For example, when a user chose in the view management window the camera positions 29b, the view management window may be triggered to zoom into the 2D digital canvas, represented as the tangent plan in FIG. 13d, and represented as a “zoom-in” planed in FIG. 13e. In this way it is easy for the dental practitioner to get a straightforward and fast overview of the drawings (i.e., illustrative user inputs) made to that specific view of the 3D digital model of a patient's teeth.

In addition, to improve the ease of use and extraction of information when using the view management window, the methods described herein also encloses an animation setup utilizing the view management window. That is, an animated workflow utilizing the view management window setup is provided, which allows a user to easily follow the sphere with e.g. a mouse or touchpad to toggle over the different cameras views and while toggling having at least the 2D digital canvas (represented by the tangent planes) quickly illustrated. In this way, the user may easily assess at which camera views of the 3D digital model of the teeth, an illustrative user input has been applied and what those user inputs are. This allows for a quick assessment of previously saved information of dental health for a patient and at the same time allows the dental practitioner to easily identify areas to look more into at a later stage in time, than for example a first visit.

The toggle path in the view management window may be represented by one or more lines between the points on the sphere which represent a path of the camera as following an animated view from one view to the other. In this way a user is able follow the camera positions, and thus the angle at which the dental data is gathered, as the camera moves along the sphere in concurrence with a smooth animation from e.g., camera position 29a to camera position 29b.

In other words in relation to the view management window, the method comprises receiving a first user input to the view management window, wherein the user input represents an activation of a first of the one or more camera positions. The first user input may create an update of the 3D model rendering to ensure that the 3D digital model is rendering from the chosen viewpoint and comprises the stored illustrative user inputs. Upon receiving a second input to the view management window, the method comprises tracking a change from the first input to a second input to the view management window, wherein the second input represents an activation of a second of the one or more camera positions. The tracking allows a simultaneous activation of updating the rendering of the 3D model in the view area based on the tracked change. In this way, the dental practitioner via interaction with the view management window, may be able to update the rendering of the 3D model camera view. In other words, the dental practitioner are not interacting directly with the 3D model, but are using the view management window to both interact with the 3D model view points, while at the same time automatically retrieving the stored information, such as the illustrative user input. Accordingly, the tracked change allows for activating an updated rendering of the 3D model in the view area based on the tracked change by updating the rendering from the first camera position to the second camera position and loading from the storage media a stored 2D digital canvas associated with the second camera position into the view area of the 3D model wherein the illustrative user inputs have previously been stored.

In general, the methods described herein may be configured to be executed by a computer readable medium 11 as illustrated in relation to FIG. 2. The computer readable medium may be configured to execute instructions forming part of an application module or be in communicatively contact with an application module as described herein. Accordingly, disclosed is also a computer readable medium configured to store instructions that, when executed by a computer, cause the computer to perform a method of rendering interactive digital three-dimensional dental models of a patient into a graphical user interface, the method comprising:
generating in the graphical user interface a digital space comprising at least one user interaction element;
rendering in the digital space at least a first 3D digital model comprising dental information of a patient;
generating and superimposing a 2D digital canvas onto at least a part of the digital space including the first 3D digital model;
based on a user input to the graphical user interface, changing the size of the digital space or the relative position of the digital space and the 2D digital canvas; and
simultaneously applying a 2D transformation to one or more illustrative user inputs on the 2D digital canvas depending on the change in relative position of the digital space and the 2D digital canvas. The computer readable medium may be considered as an entity configured to perform instructions encoded into one or more application modules (as described throughout the disclosure), wherein the application modules comprise specific methods described.

Furthermore, disclosed is a computer program product embodied in a non-transitory computer readable medium comprising computer readable program code configured to be executed by a hardware processor to cause the hardware data processor to perform the methods described herein when the computer readable program code is executed by the hardware data processor.

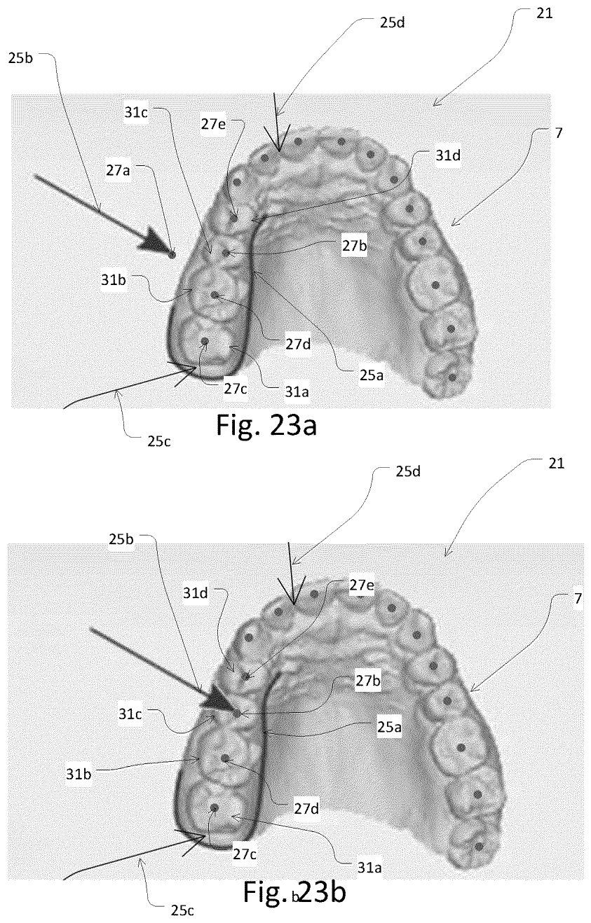

In addition to the already described examples, the method may comprise that the one or more illustrative user input(s) applied to the 2D digital canvas is/are transformed onto the 3D digital model at one or more areas or areas of interest of the 3D digital model as defined by a user. This ensures that the illustrative user inputs may be “snapped” to a specified area of interest of the 3D digital model, such as an area indicating a dental condition. An example of implementation of a “snap-to-model” application of the methods described is shown in FIGS. 23a and 23b. In FIG. 23a, the 3D digital model 7 is illustrated in the digital space 21 together with the illustrative user inputs 25a, 25b, 25c, 25d. Here the illustrative user input 25a, 25c and 25d is configured as arrows, whereas illustrative user input 25b is configured as a spline drawn to e.g., represent gingiva or any other suitable representation of the oral cavity. The arrow 25b should be considered as having been drawn in relation to a specific dental condition or observation of a specific tooth. That is, when the “snap-to-model” application is activated in relation to e.g., drawing the arrow 25b, the snap-to-model application module is configured to perform the method of connecting an illustrative user input, such as the arrow 25b to specific areas on the 3D digital model, such a tooth, where a plurality of teeth is seen in FIG. 23a. The method performed is configured to detecting the form, shape or textural content of the illustrative user input (e.g., using shape recognition). That is, the method detects e.g., the shape of the arrow 25b and further identifying a first landmark forming part of the illustrative user input, in this case the arrow 25b, where the first landmark is seen as the point 27a. Further, the method is configured to identifying a second landmark forming part of an area of interest on the 3D digital model. This second landmark is in the example shown in FIG. 23a illustrated as a second point 27b to which the arrow should snap. The snapping of the first landmark of the illustrative user input to the second landmark of the 3D digital model 7 is configured by translating the first landmark 27a of the illustrative user input to the second landmark 27b forming part of an area of interest on the 3D digital model. In this way the specific drawings provided onto the 2D digital canvas in the form of an illustrative user input may be snapped to a specific area of interest (as given by a landmark) on e.g., a specific tooth, a plurality of teeth, areas of interest of e.g., the gingiva etc. This snapping of the tip of the arrow 27b to the tooth area of interest is illustrated in the change happening between FIG. 23a and FIG. 23b, where it is clearly seen on FIG. 23b that the arrow is directly connected with the landmark 27b of the tooth of interest.

Other examples of areas of interest on the 3D digital model may comprise areas with identified dental conditions, such as plaque, caries, gingivitis, gingival recession, tooth wear, cracks, malocclusion or any other possible condition that may be present in the oral cavity as previously described.

Further in addition to the just described features, the method may be configured to allow one or more illustrative user inputs to be snapped to areas of interest on the 3D digital model, whereas other illustrative user inputs may be configured as illustrative user inputs free of snapping to the model. This is illustrated in FIG. 23a and FIG. 23b, where it is seen that only the illustrative user input recognized as an arrow 27a is snapped onto the 3D digital model.

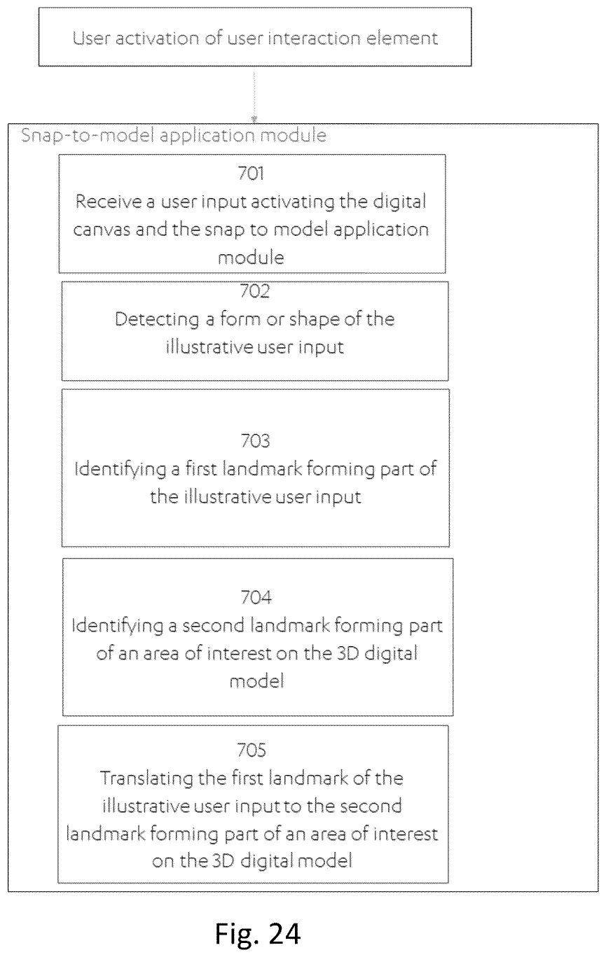

In more detail, the “snap-to-model” application module upon activation 701 by receival of a user input activating the digital canvas and the snap-to-model application module as seen in FIG. 24, performs the method of detecting a form of shape of the illustrative user input 702, e.g. by using shape recognition; identifying 703 a first landmark forming part of the illustrative user input; identifying 704 a second landmark forming part of an area of interest on the 3D digital model; and translating 705, the first landmark of the illustrative user input to the second landmark forming part of the area of interest on the 3D digital model, as illustrated in the flow of FIG. 24.

In an example one or more first landmarks of the illustrative user input may be translated into one or more second landmarks of the 3D digital model. This may e.g., be the case where a gingival margin has been drawn onto the 3D digital model via an illustrative user input to the 2D digital canvas to reflect e.g., gingival recession. Such an example application is also illustrated in FIGS. 23a, and 23b, where the illustrative user input 25a represents a spline drawn to reflect e.g., a gingival of part of the oral cavity. In this case the spline is configured with a plurality of points (not shown) representing the first landmark of the illustrative user input. The plurality of landmarks may with the methods described herein be translated onto a plurality of landmarks on one or more teeth as illustrated in FIG. 23a. That is, for each of the tooth 31a, 31b, 31c, 31d a corresponding landmark 27c, 27b, 27d, 27e is identified using the method. In this case it is the center of the tooth that have been identified. Having identified the first landmarks of the spline 25a and the second landmarks 27c, 27b, 27d, 27e of the tooth, using the method it is possible to translate the one or more first landmarks of the spline 25a onto the 3D digital model using the one or more second landmarks for each tooth. In this way it is ensured that the spline is connected to specified areas of interest on the 3D digital model.

Other possible examples have been described previously and even though not illustrated in further details, should be considered as forming part of the possible application of the method described herein.

### A Dental Scanning System

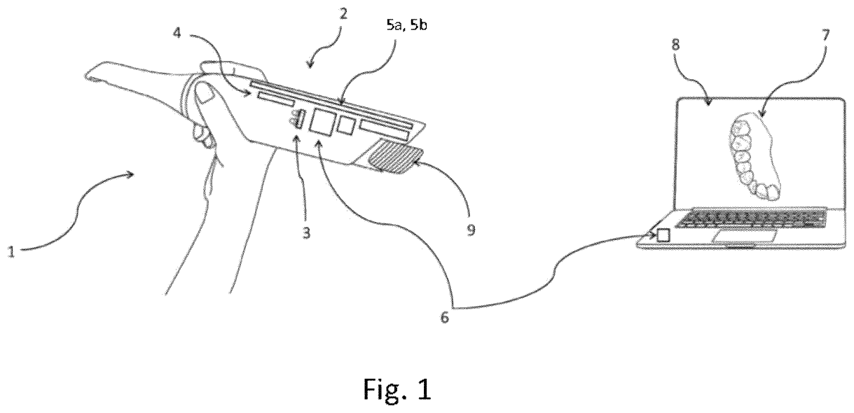

Generally, a dental scanning system 1 according to the disclosure as disclosed herein is as an example shown in FIG. 1. FIG. 1 shows a dental scanning system 1 for scanning an intraoral object (such as an oral cavity) of a patient and/or determining a health-condition and/or a probability thereof based on scanning of the intraoral object. The scanning system 1 comprises a scanning device 2 (such as an intraoral scanner) to scan the intraoral object. The scanning device 2 comprises an illumination-unit 3 configured to illuminate the intraoral object with light; an image-sensor 4 configured to record images of light from the illuminated intraoral object; an illumination-controller 5a configured to operate the illumination-unit 3 in one or more modes of illumination depending on the intended use of scanning device 2. The scanning device 2 may further comprise an acquisition controller 5b configured to operate the image-sensor 4 in one or more acquisition modes, wherein the scanning device 2 may be configured to change between the one or more illumination modes, whereby the scanning device 2 forms one or more datasets of the intraoral object in dependence of the one or more illumination-modes. The scanning device 2 is further configured to change between the one or more acquisition modes, whereby the scanning device forms one or more dataset of the intraoral object in dependence on the one or more acquisition modes. Furthermore, the scanner may comprise a battery 9. A data processor 6 of the scanning system 2 may in dependence of the illumination and acquisition mode be configured to form, from a first dataset of the one or more datasets, a 3D-model (also denoted a 3D digital model) 7 of the intraoral objects and to form, from e.g., a second dataset of the one or more datasets, a 2D-image of the intraoral object and/or further details of the 3D-model. Further the scanning system 1 may be configured to apply, on the 2D-image and/or the 3D-model 7, a diagnostic algorithm to identify a diagnostic feature of the intraoral object and determine, based on the diagnostic feature of the intraoral object, the health-condition and/or probability thereof.

Accordingly, in all examples of the disclosure, the dental scanning system 1, as illustrated in FIG. 2 may comprise a computer device 10 comprising a computer readable medium 11 and a microprocessor 12. The system 1 further comprises a display unit 8, a computer keyboard or touchpad 14, a computer mouse or touchscreen 15 for entering data and activating virtual buttons (user interaction elements) visualized on the visual display unit 13. The visual display unit 13 can be a computer screen or a touchpad screen comprising a graphical user interface and having a display unit 8, whereon the 3D-model 7 and e.g., a health-condition and/or the probability thereof are displayed. Further the dental scanning system may comprise a storage media/medium 16 configured to store data, such as acquired scan data form the scanning device 2 in relation to specific patient records, analysis data, patient specific identification data, diagnostic data etc. The storage media/medium 16 may be configured as a cloud storage or for example storage on multiple computer services, which are configured to communicate with each other over a network. Accordingly, the processing and storage of the data relevant for analysis may be performed in a cloud setup and loaded into a computer therefrom.

Furthermore, the dental scanning system may include a wireless capability as provided by a wireless network unit. The network unit may be configured to connect the dental scanning system to a network comprising a plurality of network elements including at least one network element configured to receive processed data from the dental scanning device or system. The network unit may include a wireless network unit or a wired network unit. The wireless network unit is configured to wirelessly connect the dental scanning system to the network comprising the plurality of network elements including the at least one network element configured to receive the processed data. The wired network unit is configured to establish a wired connection between the dental scanning system and the network comprising the plurality of network elements including the at least one network element configured to receive the processed data.

### Dental Scanning Device

The scanning device 2 may in more detail employ a scanning principle such as triangulation-based scanning, confocal scanning, focus scanning, ultrasound scanning, x-ray scanning, stereo vision, structure from motion, optical coherent tomography OCT, or any other scanning principle. In an embodiment, the scanning device is operated by projecting a pattern and translating a focus plane along an optical axis of the scanning device and capturing a plurality of 2D images at different focus plane positions such that each series of captured 2D images corresponding to each focus plane forms a stack of 2D images. The acquired 2D images are also referred to herein as raw 2D images, wherein raw in this context means that the images have not been subject to image processing. The focus plane position is preferably shifted along the optical axis of the scanning system, such that 2D images captured at a number of focus plane positions along the optical axis form said stack of 2D images (also referred to herein as a sub-scan) for a given view of the object, i.e., for a given arrangement of the scanning system relative to the object. After moving the scanning device relative to the object or imaging the object at a different view, a new stack of 2D images for that view may be captured. The focus plane position may be varied by means of at least one focus element, e.g., a moving focus lens. The scanning device is generally moved and angled during a scanning session, such that at least some sets of sub-scans overlap at least partially, in order to enable stitching in the post-processing. The result of stitching is the digital 3D representation of a surface larger than that which can be captured by a single sub-scan, i.e., which is larger than the field of view of the 3D scanning device. Stitching, also known as registration, works by identifying overlapping regions of 3D surface in various sub-scans and transforming sub-scans to a common coordinate system such that the overlapping regions match, finally yielding the digital 3D model. An Iterative Closest Point (ICP) algorithm may be used for this purpose. Another example of a scanning device is a triangulation scanner, where a time varying pattern is projected onto the dental object and a sequence of images of the different pattern configurations are acquired by one or more cameras located at an angle relative to the projector unit.

The scanning device 2 may in more detail comprise one or more light projectors configured to generate an illumination pattern to be projected on a three-dimensional dental object during a scanning session. The light projector(s) preferably comprises a light source, a mask having a spatial pattern, and one or more lenses such as collimation lenses or projection lenses. The light source may be configured to generate light of a single wavelength or a combination of wavelengths (mono-or polychromatic). The combination of wavelengths may be produced by using a light source configured to produce light (such as white light) comprising different wavelengths. Alternatively, the light projector(s) may comprise multiple light sources such as LEDs individually producing light of different wavelengths (such as red, green, and blue) that may be combined to form light comprising the different wavelengths. Thus, the light produced by the light source may be defined by a wavelength defining a specific color, or a range of different wavelengths defining a combination of colors such as white light. In an embodiment, the scanning device comprises a light source configured for exciting fluorescent material of the teeth to obtain fluorescence data from the dental object. Such a light source may be configured to produce a narrow range of wavelengths. In another embodiment, the light from the light source is infrared (IR) light, which is capable of penetrating dental tissue. The light projector(s) may be DLP projectors using a micro mirror array for generating a time varying pattern, or a diffractive optical element (DOF), or back-lit mask projectors, wherein the light source is placed behind a mask having a spatial pattern, whereby the light projected on the surface of the dental object is patterned. The back-lit mask projector may comprise a collimation lens for collimating the light from the light source, said collimation lens being placed between the light source and the mask. The mask may have a checkerboard pattern, such that the generated illumination pattern is a checkerboard pattern. Alternatively, the mask may feature other patterns such as lines or dots, etc.

The scanning device 2 preferably further comprises optical components for directing the light from the light source to the surface of the dental object. The specific arrangement of the optical components depends on whether the scanning device is a focus scanning apparatus, a scanning device using triangulation, or any other type of scanning device. A focus scanning apparatus is further described in EP 2 442 720 B1 by the same applicant, which is incorporated herein in its entirety.

The light reflected from the dental object in response to the illumination of the dental object is directed, using optical components of the scanning device, towards the image sensor(s). The image sensor(s) are configured to generate a plurality of images based on the incoming light received from the illuminated dental object. The image sensor may be a high-speed image sensor such as an image sensor configured for acquiring images with exposures of less than 1/1000 second or frame rates in excess of 250 frames pr. second (fps). As an example, the image sensor may be a rolling shutter (CCD) or global shutter sensor (CMOS). The image sensor(s) may be a monochrome sensor including a color filter array such as a Bayer filter and/or additional filters that may be configured to substantially remove one or more color components from the reflected light and retain only the other non-removed components prior to conversion of the reflected light into an electrical signal. For example, such additional filters may be used to remove a certain part of a white light spectrum, such as a blue component, and retain only red and green components from a signal generated in response to exciting fluorescent material of the teeth.

### Dental Scanning System Processor

The dental scanning system 1 preferably further comprises a processor (such as a microprocessor 12) configured to process scan data (such as extra-oral scan data and/or intra-oral scan data) by processing the two-dimensional (2D) images (i.e., the scan data) acquired by the scanning device. The processor 12 may be part of the scanning device or may form part of an external processor to the scanner device such as a computer, cloud service or other processer being in communicatively connection with the scanning device, as illustrated in FIG. 2, where the processor 6 may be external to the scanning device and/or external to the computing device. As an example, the processor may comprise a Field-programmable gate array (FPGA) and/or an Advanced RISC Machines (ARM) processor located on the scanning device or external thereto.

The scan data comprises information relating to the three-dimensional dental object. The scan data may comprise any of: 2D images, 3D point clouds, depth data, texture data, intensity data, color data, and/or combinations thereof. As an example, the scan data may comprise one or more-point clouds, wherein each point cloud comprises a set of 3D points describing the three-dimensional dental object. As another example, the scan data may comprise images, each image comprising image data e.g., described by image coordinates and a timestamp (x, y, t), wherein depth information can be inferred from the timestamp. The image sensor(s) of the scanning device may acquire a plurality of raw 2D images of the dental object in response to illuminating said object using the one or more light projectors. The plurality of raw 2D images may also be referred to herein as a stack of 2D images. The 2D images may subsequently be provided as input to the processor, which processes the 2D images to generate scan data. The processing of the 2D images may comprise the step of determining which part of each of the 2D images are in focus in order to deduce/generate depth information from the images. The depth information may be used to generate 3D point clouds comprising a set of 3D points in space, e.g., described by cartesian coordinates (x, y, z). The 3D point clouds may be generated by the processor or by another processing unit. Each 2D/3D point may furthermore comprise a timestamp that indicates when the 2D/3D point was recorded, i.e., from which image in the stack of 2D images the point originates. The timestamp is correlated with the z-coordinate of the 3D points, i.e., the z-coordinate may be inferred from the timestamp. Accordingly, the output of the processor is the scan data, and the scan data may comprise image data and/or depth data, e.g., described by image coordinates and a timestamp (x, y, t) or alternatively described as (x, y, z). The scanning device may be configured to transmit other types of data in addition to the scan data. Examples of data include 3D information, texture information such as infra-red (IR) images, fluorescence images, reflectance color images, x-ray images, and/or combinations thereof.

### Dental Scanning System Display Unit

For the dentist to get a visualization of the acquired scan data, the dental scanning system 1 provides for a visualization in the form of a graphical user interface utilizing a visual display unit 13 to visualize the acquired scan data in a suitable manner for further analysis of the scan data. Accordingly, the scanning system is configured to utilize the microprocessor to communicate with a display unit 8 whereby the acquired scan data can be displayed in e.g., a digital space on the display unit. In the digital space, the scanning system is via the computing device 10 configured to render and display the 3D digital information (e.g., a 3D model 7 of the at least a part of the oral cavity or dental arch of a patient) generated from the scan data. The displaying of the acquired scan data may be done by selecting from the storage media/medium 16 for example one or more stored patient record(s) to display, analyze and/or evaluate further details.

A patient specific record may contain one or more scan data acquired from scanning a specific patient at one or more point in times.

### Computer Readable Media/Medium & Application Modules

For the analysis of a patient record to be performed by a dental practitioner, the scanning system 1 comprises at least a computer-readable medium 11 storing instructions that, when executed by the computer device (e.g. by the microprocessor 12), cause it to perform a specified method of e.g. detection, classification, quantification, monitoring, prevention, evaluation, visualization, record documentation or storage and/or any other analysis of the patient record loaded into the computer device after recorded by e.g. an intraoral scanning device 2. Each of the methods performed may be implemented in one or more application modules configured to perform a specific method and to be activated by a user.

The methods executed by the computer readable medium as instructed via an application module may (in addition to the specific analysis being performed by a specific method) be configured to output to the display unit 8 an analysis guidance, such as an application having a specified workflow, assisting the dental practitioner in performing the analysis of the patient specific record. The workflow may comprise assistance processes guiding the practitioner through the different analysis needed to get picture of the oral health of the patients' oral cavity.

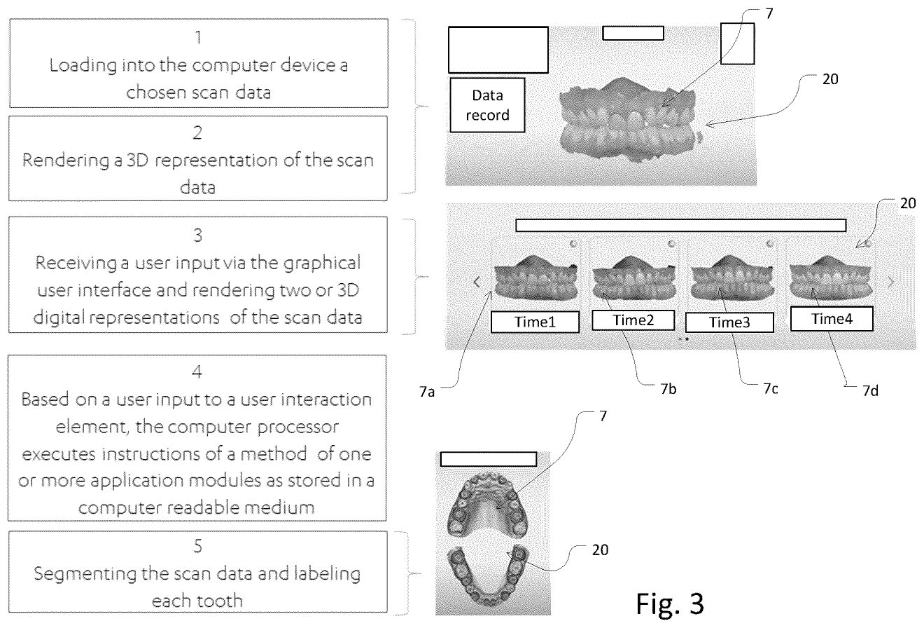

In an exemplary application of at least one method, the scanning system may be configured to utilize the computer device 10 to perform a method (as executed by the computer readable medium/media) of loading into the computer device a user chosen patient specific data record 10, chosen on the basis of a user input to the graphical user interface 20 of the display unit 8; and rendering into the display unit 8 a 3D digital representation 7 of at least one scan data contained in the patient specific data record, as illustrated in process 1 and 2 of FIG. 3.

The patient specific record may contain one or more data records, recorded by an intraoral scanner at different points in time. Accordingly, a dental practitioner may choose one or more data records from the patient specific record to analyze. Therefore, in a further process 3 as illustrated in FIG. 3, of an exemplary application of the scanning system 1, the method may comprise receiving a user input from the graphical user interface and rendering based on the user input two or more 3D digital representation 7a, 7b, 7c, 7d from the patient record into the graphical user interface 20 of the display unit 8. The two or more 3D digital representations 7a, 7b, 7c, 7d may be configured with a time stamp indicating the date at which the data was acquired by a scanning device 2.

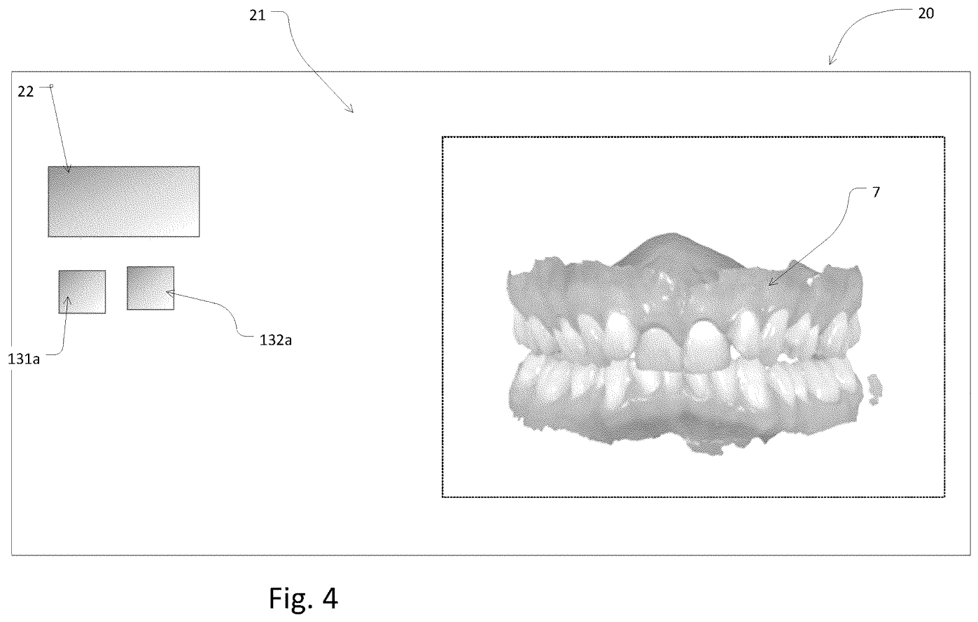

The further analysis of the chosen data from the patient specific record data may then be further analyzed utilizing one or more modules of the application setup. That is, the graphical user interface 20 (as displayed on the display unit 8) of the scanning system may comprise one or more user interaction elements 22a, 22b, 22c, which when activated by a user instructs the computer readable medium to execute a specific method related to an application module of the specific user interaction element. The user interaction elements should be considered as virtual push buttons in the graphical user interface which the user may press to activate the underlying methods, also denoted as application modules. Thus, the computer device may further comprise one or more application modules 13 configured to instruct a computer readable media and/or being in communicatively contact with a computer readable media and having stored thereon instructions to perform a specified method. FIG. 4 illustrates a simplified version of a graphical user interface 20 as described herein. In this simplified version, the graphical user interface 20 comprises a user interaction element 22 and a rendered 3D digital model 7, all configured to be displayed in a digital space 21. The user interaction element 22 is configured to activate an application module to perform a specific method of that application module. Accordingly, the methods described herein may further comprise based on a user input to a user interaction element 22, the computer processor executes instructions of a method of one or more application modules as stored in a computer readable medium, as illustrated in FIG. 3, process 4.

Depending on the analysis to be performed using the computer device of the dental scanning system 1, a segmentation of the patient data recorded of interest may be performed. Thus, in a further process, an application module may, as a part of the method, be configured to perform a segmentation of the scan data of the patient record, wherein the segmentation is configured to separate the scan data into teeth and gingiva, as illustrated in FIG. 3, box 5. In addition to the segmentation of the data, the method may also be configured to perform a labeling of each tooth (such as numbering of the teeth). As illustrated in FIG. 3, box 5, the system is configured to display a representation of the segmentation of the scan data chosen for analysis. The segmentation of the scan data into gingiva and tooth may be done automatically by the computing device or may be done manually by the practitioner utilizing the computing device. In any case the user (such as a dentist) may in the graphical user interface be prompted with the possibility of approving and accepting the segmentation and/or to modify the segmentation for the scan data undergoing analysis. The segmentation may further be comprised of segmenting the scan data into other relevant features of the dental scan data, such as implants of the teeth, braces applied to the teeth, fillings and any other possible change to the teeth not being natural tooth or gingiva.

The specific methods as performed by a specified application module may be elaborated on in detail in different sections of this disclosure. The computer device of the scanning system may utilize a plurality of application modules configured with different methods performing analysis of the data, wherein the plurality of application modules may be considered as a combined patient monitoring system.

### An Exemplary Application Module

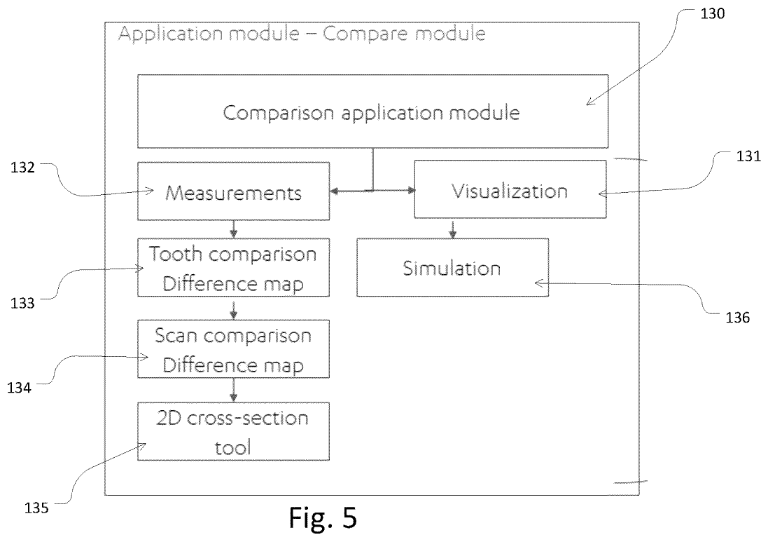

As an example, an application module may be configured as for example a comparison module, wherein the general processes 1 to 5, described in relation to FIG. 3, may be configured as part of the comparison module. The comparison module is in further detail configured to perform a comparison of two or more digital 3D representation of the patient's set of teeth as obtained by an intraoral scanner device, as illustrated in FIG. 5, where an example of a comparison module 130 is shown. That is, when a user activates the comparison module by activating a specific user interaction element in the graphical user interface, the method provided by the comparison module is instructed to be performed. In the exemplary case described in this section, the comparison module comprises a plurality of sub-module applications or methods 131, 132, 133, 134, 135, 136 as illustrated in FIG. 5, which may be performed if chosen by the user. That is, each sub-method is configured to be activated through a corresponding user interaction element, illustrated for example as sub-module elements 131a and 132a in FIG. 4. In an example, when activating by a user, the comparison application module via e.g., the user interaction element 22 in FIG. 4, the computer device at the same time enables the one or more sub-module elements 131a, 132a in the graphical user interface, each activating a sub-module application or method is chosen by the user. Each of these sub-module elements may be interactively activated by a user pressing the sub-module element virtual button, which subsequently activates the underlying sub module methods or applications to be performed the computer device. Examples of sub-methods may include methods for providing a tooth comparison difference map, providing a scan comparison difference map and/or providing a 2D-cross sectional tool, as illustrated in FIG. 5 and all configured to assist the dental practitioner in analyzing the scan data of a patient specific record loaded into the computing device.

In the context of this application the 3D digital model described herein comprises information about the oral health of teeth of the patient being scanned. That is the data record used to generate the 3D model and render the 3D digital model in the digital space may comprises information on one or more dental conditions of the oral cavity of the person being scanned. Accordingly, for the purpose of providing an efficient analysis of the dental data (i.e., patient record) provided with the scan data, an oral health assessment software may be configured with different application modules which may be configured to detect, classify, quantify, monitor, predict, prevent and/or record a dental condition of a patient's oral cavity. In general, dental diseases usually progress with time, and in absence of proper care may lead to irreversible situations that may even lead to extraction of diseased tooth. Therefore, early detection, classification, quantification, monitoring, prediction, prevention and/or recording the development of dental condition is desirable. This would allow for timely undertaking preventive or corrective measures ensuring increased patient health.

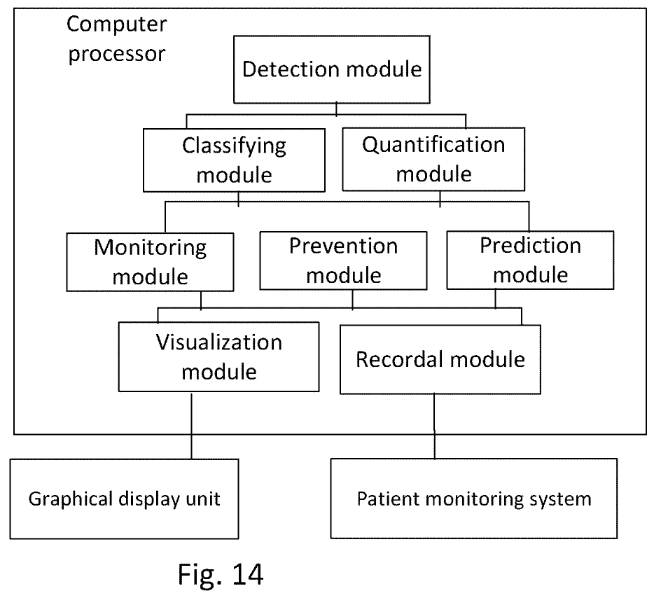

Accordingly, an oral health assessment software of the dental system may be configured to perform one or more evaluations of the oral health of a patient by for example detecting a dental condition, classifying the severity and/or providing a quantitative measure of the dental condition, monitoring the dental health of the oral cavity of a patient by assessing the development of different dental conditions, providing a predictive measure of the development of the dental health, assessing preventive measures of the oral health, as well as visualizing to the patient and to the dental practitioner him/her self the results of the evaluation of the dental health of an oral cavity. Furthermore, the oral health software may also provide for application modules configured to store and record dental data, transmit to external entities etc. to ensure that the dental practitioner, the user etc. can assess a previous evaluation of the oral health of a patient at a later point in time. Accordingly, the system described herein may be configured with a computer processor that comprises application modules configured as a detection module, a classifying module, a quantification module, a monitoring module, a preventive module, a prediction module, a visualization module and/or a recordal module as illustrated in FIG. 14. Each of the application modules may perform specific methods for detection, classifying, quantifying, monitoring, preventing, predicting, visualizing and recording, respectively. Further each of the modules may be activated by a user from user interaction elements in the graphical user interface. It is possible that some of the modules automatically activates other modules, whereas other modules may be activated independent from others. Each of the modules may output results to the graphical user interface and/or all or some or the application modules may ensure transfer of data to for example a patient monitoring system.

The application modules as referred to herein and described throughout the description, should be understood as code stored at one or more computer readable media. Further, the application modules may be configured to communicate with each other to execute respective codes in an ordered manner and/or in an independent entity. Further, a remotely situated computer readable media configured with instruction of an application module may also communicate with e.g., a clinical site to execute the instructions provided with the application module from a remote location. Further an application module can be considered as a computer program module.

### Dental Conditions

As elaborated on, different dental conditions that may be relevant to assess using an oral health assessment software may include one or more of the following conditions.

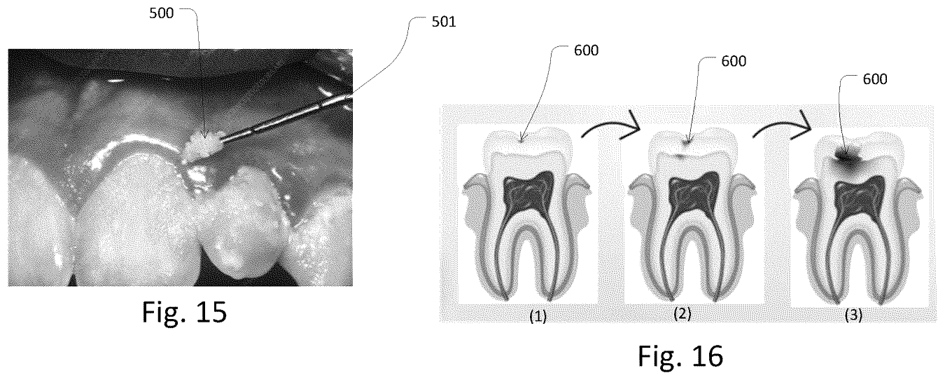

Dental plaque, which is a bacterial biofilm that accumulates on the tooth surface and is associated with and a significant risk factor for the most prevalent oral diseases worldwide affecting people of all ages. When dental plaque accumulates on the crowns of teeth, the natural, smooth, shiny appearance of the enamel is lost, and a dull and matt effect is produced. As it builds up, masses of dental plaque become more readily visible to the naked eye. After a few days of accumulation of dental plaque on the tooth surface, the biofilm matures and creates risk for development of dental caries, gingivitis, and periodontal diseases. An example of dental plaque 500 can be seen in FIG. 15, where it is seen how a dental practitioner when using a probe 501 may identify plaque on a patient's teeth. Application modules described herein may be configured to automate the detection of plaque in software setup rather than a manually probing process.

Caries, which is also referred to as tooth decay or cavities, is one of the most common and widespread persistent diseases today and is also one of the most preventable. Typically, dental caries may be spotted as occlusal caries, which form on the top-most part of the tooth where food particles repeatedly come in direct contact with the teeth. It's in this location where bacteria fester and pose a risk to one's oral hygiene. If the teeth and surrounding areas are not cared for properly, the bacteria will begin to digest the sugars left over from food in the mouth and convert it into acids as a waste product. These acids may be strong enough to demineralize the enamel on one's teeth and form tiny holes—the first stage of dental caries. As the enamel begins to break down, the tooth loses the ability to reinforce the calcium and phosphate structures of the teeth naturally through saliva properties and, in time, acid penetrates the tooth and destroys it from the inside out. Despite the impact tooth decay may have on one's teeth if left unattended, dental caries or cavities are largely preventable with a good oral hygiene regimen. This includes regular dental checkups. The dentist typically looks at the teeth and may probe them with a tool called an explorer to look for pits or areas of damage. The problem with these methods is that they often fail to identify cavities when these cavities are just forming. Occasionally, if too much force is used, an explorer may puncture the porous enamel. This could cause formation of irreversible cavity formation and allow the cavity-causing bacteria to spread to healthy teeth. Caries that has destroyed enamel cannot be reversed. Most caries will continue to get worse and go deeper. With time, the tooth may decay down to the root which will cause severe discomfort for the patient if not treated. How long this takes varies from person to person and the general level of oral hygiene. Caries caught in the very early stages can be reversed. White spots may indicate early caries that has created a porous structure in the enamel. In early stages of caries development, tooth decay may be stopped. It may even be reversed as the material dissolved in the enable might be replaced. Fluorides and other prevention methods also help a tooth in early stages of decay to repair itself (remineralize). Brown/black spots are the last stage of early caries. Once caries gets worse the porous tooth structure may collapse creating irreversible cavities in the enamel, hence only the dentist can repair the tooth. Then the standard treatment for a cavity is to fill the tooth with fillings typically made of dental amalgam or composite resin. Sometimes bacteria may infect the pulp inside the tooth even if the part of the tooth one may see remains relatively intact. In this case, the tooth typically requires root canal treatment or even extraction of the damaged tooth. It may be observed that development of caries is a process where dental caries may be easily treated if detected early. If undetected and untreated, caries may progress through the outer enamel layer of a tooth into the softer dentin so far as to require extraction of the tooth or to cause inflammation of periodontal tissue surrounding the tooth. An example of the development of caries can be seen in FIG. 16, where three points in time (1), (2), (3), is illustrated together with a development of caries 600 on a tooth.

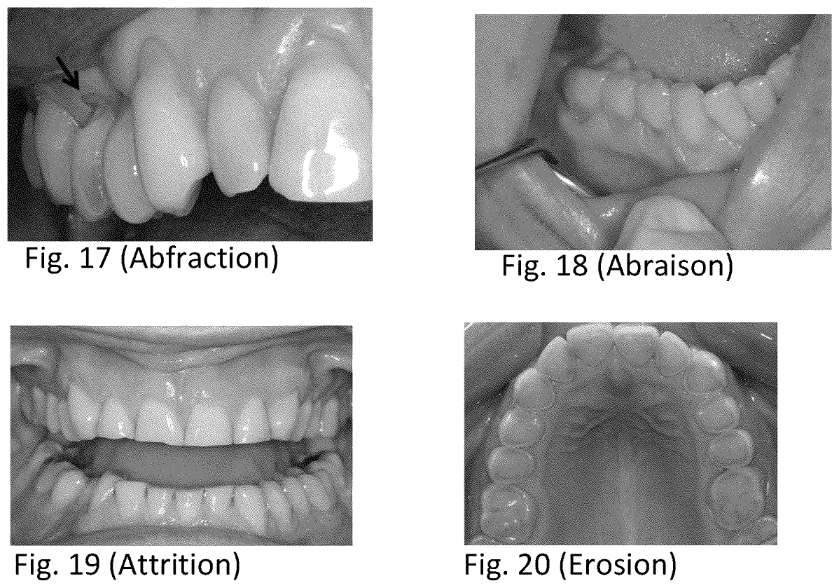

Tooth wear is the gradual but persistent reduction of tooth substance. Tooth wear is generally not caused by dental decay (caries) or diseases but is a gradual and consistent process that may cause increased tooth sensitivity, reduction of the vertical dimension and compromised aesthetics. Different types/classes of tooth wear exist and will be explained in the following in connection with FIGS. 17 to 20.

Abfraction, illustrated in an example in FIG. 17, is the mechanical form of tooth wear caused by improper occlusal loading forces onto a tooth. Abfraction causes the tooth to bend at the neck region which eventually leads to failure of enamel and dentine at a location away from the loading. The result is tooth material breaking away in the area of tension and eventually over time, leaving wedge-shaped grooves near the gum line.

Abrasion, illustrated in FIG. 18 is another type of tooth wear caused by external objects/substances caused by wrong dental hygiene habits (for example tooth brushing). Abrasion is typically visible on several consecutive teeth at the cervical area of the teeth especially on canines and premolars.

A further tooth wear type illustrated in FIG. 19 is called attrition which is a mechanical from of tooth war caused by physical tooth-to-tooth action. To some extend attrition forms part of a normal aging process due to the functional use of the teeth during the lifetime but may also be a cause of malocclusion and bruxism. Attrition may be visible on individual, many or on all teeth (depending on the severity/state).

Furthermore, tooth wear, as illustrated in FIG. 20 may be classified as erosion which is a chemical form of tooth wear caused by acids that get exposed onto the teeth. Erosive tooth wear may be visible on the palatal surface of the upper incisors and occlusal surfaces on the posterior teeth

Gingiva recession is a periodontal condition where the gum (gingiva) around the tooth will recede, exposing the root of the tooth. In more detail, gingiva recession is the displacement of the gingival margin apical to the Cemento-Enamel Junction (CEJ) of a tooth or the platform of a dental implant first the neck and later also the root of a tooth gets exposed. In a healthy state of the oral cavity, the CEJ is hidden/covered with gingiva (the gingival margin of the attached gingiva) and is therefore not visible. Different types/classes of gingiva recession exist, including:
General/horizontal recession where the gingival margin has generally/horizontally shifted apical on several consecutive/all teeth within the dental arch.
Local recession, where the gingival margin has shifted apical only on an individual or some none-consecutive teeth

Malocclusion is the incorrect correlation between the upper and lower teeth to each other.

Bruxism is excessive teeth grinding or jaw clenching. It is an oral parafunctional activity, i.e., it is unrelated to normal function such as eating or talking.

A cracked tooth is an incomplete fracture originating from the chewing surface of the tooth and extends vertically toward the root of the tooth. A cracked tooth can result from chewing on hard foods, grinding your teeth at night, and can even occur naturally as you age. Cracks in teeth vary in severity. Some are mild and invisible, while others are significant and cause a lot of pain. It's a common condition and the leading cause of tooth loss in industrialized nations.

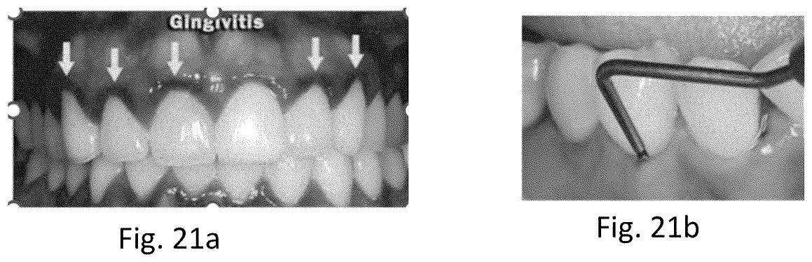

Gingivitis, as illustrated in FIG. 21a is an inflammatory condition of the gingival tissue, most caused by bacterial infection. Gingivitis is characterized by swelling, redness, exudate, a change of normal contours, bleeding, and, occasionally, discomfort. Gingivitis affects over 90% of the world population to some degree and is prevalent at all ages (Coventry et al., ABC of oral health: periodontal disease, BMJ, 2000). The manifestations of gingival inflammation are vascular changes consisting essentially of increased volume of crevicular fluid and increased blood flow at the marginal gingival region, and clinically, gingiva will appear with edema, less stippled, and more red than healthy gingiva. Diagnosis of gingivitis by the clinician relies on the identification of signs and symptoms of inflammation resulting from the disease process in the gingival tissues, and is based on inspection of the color, texture, edema of gingiva, and bleeding on probing. The assessment is either noninvasive using a visual technique, or invasive using instrumentation. Bleeding, as illustrated in FIG. 21b is an early sign of gingivitis and clinical assessment is often based on invasive use of a periodontal probe, and the suitability of bleeding provocation in the gingival margin is dependent on the probing pressure. In general, measurement of the gingival inflammation is subjective in nature and requires expert examiner training and knowledge to examine a patient at multiple sites to arrive at an appropriate diagnosis and management strategy. The assessment can be time-consuming and uncomfortable for the patient. Gingivitis is reversible with professional treatment, patient motivation, and good oral hygiene instruction, which is central for regenerating healthy gingiva without irreversible damage. However, patients are often unaware that they are suffering from gingivitis before it is diagnosed and being demonstrated to them when they attend a dental appointment (Blicher et al., Validation of self-reported periodontal disease: a systematic review, J Dent Res, 2005). Gingivitis is the first and mildest stage of progression of periodontal disease, and if left untreated it can lead to presence of an abnormal depth of the gingival sulcus (periodontal pocket), loss of jawbone surrounding the teeth, and eventually tooth loss. Therefore, an early diagnosis is crucial for preventing periodontal diseases. Development of non-invasive techniques, such as methods mentioned in the disclosure, which could predict the changes in microcirculation and morphology related to the condition would rather have high significance in the diagnosis or monitoring of gingival/periodontal diseases.

Periodontal disease is a set of inflammatory conditions affecting the tissues surrounding the teeth, starting with gingivitis in its early stage. In its more serious form (periodontitis), gingiva can pull away from the tooth and a space between the tooth and the surrounding gingiva is formed (periodontal pocket). Periodontal pockets provide an ideal environment for bacteria to grow and may spread infection to the structures that keep teeth anchored in the mouth, and the underlying bone is destroyed (bone loss). As periodontal disease advances leading to more bone loss, the teeth may loosen or fall out. The prevalence of periodontitis is high and a report from US showed that 47.2% of adults aged 30 years and older have some form of periodontal disease, and the prevalence increases with age were 70.1% of adults 65 years and older have periodontal disease (Eke et al., Prevalence of Periodontitis in Adults in the United States: 2009 and 2010. J Dent Res. 2012).

The most frequently used diagnostic tool for assessing the health status and attachment level of the tissues surrounding the teeth is a periodontal probe, which is placed between the gingiva and the tooth, as illustrated e.g., in FIG. 21b. This clinical assessment is very time-consuming and thus also expensive, is unpleasant for the patient, and also lacks reproducibility (Shayeb et al., 2014). To fill out a detailed periodontal chart, typically, 6 sites per tooth are probed, and for full-mouth pocket depth measurement, the dentist or the hygienist uses up to 20 min for probing and measuring the pocket depth of a patient. Furthermore, it is well known that the traditional periodontal probing shows insufficient reproducibility and accuracy, due to significant differences in individual techniques, probe instrument, and variation in probing depth force, even among different operators or even the same operator at different times (Theil et al., 1991), (Andrade et al., 2012). The resulting errors can impact clinical decision-making, especially during longitudinal monitoring of the periodontal status.

All of the above-mentioned dental diseases are often detected manually by a dental practitioner, and therefore one or more applications comprising methods to be executed described herein, aims at detecting, quantifying, classifying, monitoring such diseases in automated manner to assist the dental practitioner in assessing efficiently and quickly the oral health of a patient, by for example providing preventive measures, predictive measure and record potential finding.

### Workflow Utilizing Intraoral Diagnostic Software

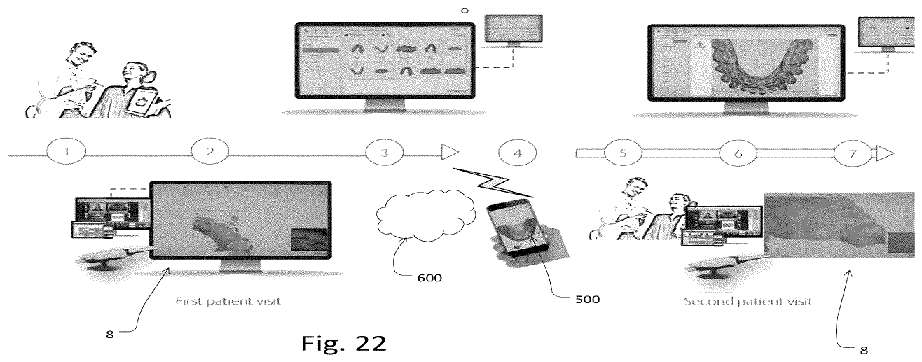

As previously elaborated a patient may visit a dental practitioner several times to get an evaluation and treatment of their oral health. To assist the dental practitioner in assessing the oral health of a patient at a first visit and/or over time by utilizing one or more scan data taken at different times a defined workflow may form part of the dental visit. In this work flow the dental practitioner may use one or more of the application modules described herein. Thus, each of the application modules may form part of the computer system used in the workflow. In an example a workflow could look as follows with reference to FIG. 22, where in a first visit (step (1)) a patient may enter a dental clinic for a first patient visit. At this first visit the oral cavity of the patient may be assessed using an intra oral scanner as previously described. Thus, at step (1) in FIG. 22, the patient is scanned using e.g., an intraoral scanner by a dental practitioner. As can be seen in step (2) of the workflow in FIG. 22, while scanning, the dental practitioner may be able to see the scanning live on a display unit 8. This first scan may be considered as a baseline scan, for example representing a first scan taken at a first point in time as previously elaborated on. At step (3) of FIG. 22, the scan data is further analyzed utilizing one or more software applications, such as the applications modules described herein. Accordingly, at least in step (3) of the illustrated workflow, the dental practitioner may be able to utilize a provided software to analyze the oral state and health of the oral cavity of a patient by applying any of the application modules (forming part of the software) as described herein.

The step (3) of the workflow may utilize software applications (i.e., application modules) that are configured to detect, classify, monitor, predict, prevent, visualize and/or record any dental condition that may be present in the patient oral cavity. Examples of such applications are described throughout the disclosure and each of the applications may be triggered by an application module and may be configured automated procedure embedded in a computer implemented method.

The recording of the resulting analysis data may be provided by software ensuring the possibility of storing the data and analysis results in for example a dental chart, such as for example a dental chart forming a direct part of the software application or alternatively connecting directly with a patient management system.

Furthermore, as illustrated in FIG. 22, it is also possible that the dental software (including e.g., oral health assessment software) is configured to connect with for example a smart phone application 500 or a cloud service 600, whereby engagement with the patient or any other entity using the analyzed scan data beyond the dental clinic may be enabled.

All the scan data and the corresponding analysis related thereto of a patient in the first visit, represented by points (1) to (3) in FIG. 22, may be considered as baseline scan data and analysis and may be used for further dental health and state tracking when a patient undergoes a second visit.

Accordingly, after the first visit to the dental clinic, the patient may be engaging in a second visit (steps (5) to (7)), during which visit the patient undergoes a second scan of the oral health utilizing for example an intraoral scanner. This second visit provides the dental practitioner with a second scan data taken at a second point in time in comparison to the scan data that was taken at the first visit.

During the second visit the dental practitioner may again utilize analysis software applications to assess for example potential changes in the oral health of the patient in comparison to the first visit. Thus, when utilizing one or more of the application modules as described herein, the dental practitioner is enabling the possibility of analyzing the second scan data up against the first scan data thereby allowing a detection of a change in the oral health. That is the software configured as one or more of the application modules described herein may be configured to automatically or by active engagement with the software by the dental practitioner to detect a change in dental condition, providing a classification and/or quantification of a dental condition, monitor for example a development of the dental condition, provide predictive measurements, provide preventive measurements etc.

Furthermore, in relation to the first visit, also at the second visit any finding may automatically be recording in a dental chart or patient management system.

With the workflow described in FIG. 22, it is easy for the dental practitioner to track over time the development of the oral health of a patient by utilizing any one or the one or more application modules described herein.

According to examples described herein, the electronic hardware may include microprocessors, microcontrollers, digital signal processors (DSPs), field programmable gate arrays (FPGAs), programmable logic devices (PLDs), gated logic, discrete hardware circuits, and other suitable hardware configured to perform the various functionality described throughout this disclosure. Computer program shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Although some embodiments have been described and shown in detail, the disclosure is not restricted to such details, but may also be embodied in other ways within the scope of the subject matter defined in the following claims. In particular, it is to be understood that other embodiments may be utilized, and structural and functional modifications may be made without departing from the scope of the present invention.

Benefits, other advantages, and solutions to problems have been described herein with regard to specific embodiments. However, the benefits, advantages, solutions to problems, and any component(s)/unit(s) that may cause any benefit, advantage, or solution to occur or become more pronounced are not to be construed as critical, required, or essential features or components/elements of any or all the claims or the invention. The scope of the invention is accordingly to be limited by nothing other than the appended claims, in which reference to a component/unit/element in the singular is not intended to mean “one and only one” unless explicitly so stated, but rather “one or more.” A claim may refer to any of the preceding claims, and “any” is understood to mean “any one or more” of the preceding claims.

It is intended that the structural features of the devices described above, either in the detailed description and/or in the claims, may be combined with steps of the method, when appropriately substituted by a corresponding process.

As used, the singular forms “a,” “an,” and “the” are intended to include the plural forms as well (i.e., to have the meaning “at least one”), unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will also be understood that when an element is referred to as being “connected” or “coupled” to another element, it can be directly connected or coupled to the other element, but an intervening element may also be present, unless expressly stated otherwise. Furthermore, “connected” or “coupled” as used herein may include wirelessly connected or coupled. As used herein, the term “and/or” includes any and all combinations of one or more of the associated listed items. The step of any disclosed method is not limited to the exact order stated herein, unless expressly stated otherwise.

It should be appreciated that reference throughout this specification to “one embodiment” or “an embodiment” or “an example” or features included as “may” means that a particular feature, structure or characteristic described in connection with the embodiment is included in at least one embodiment of the disclosure. Furthermore, the particular features, structures or characteristics may be combined as suitable in one or more embodiments of the disclosure. The previous description is provided to enable any person skilled in the art to practice the various examples described herein. Various modifications to these examples will be readily apparent to those skilled in the art, and the generic principles defined herein may be applied to other examples.

The claims are not intended to be limited to the examples shown herein but is to be accorded the full scope consistent with the language of the claims, wherein reference to an element in the singular is not intended to mean “one and only one” unless specifically so stated, but rather “one or more.” Unless specifically stated otherwise, the term “some” refers to one or more.

1. A computer implemented method for rendering interactive digital three-dimensional dental models of a patient in a graphical user interface, the method comprising:
generating in the graphical user interface a digital space configured as a 2D scene and comprising at least one user interaction element arranged in the 2D scene;
rendering in a 3D viewing area of the 2D scene at least a first 3D digital model comprising dental information of a patient, wherein the rendering is configured as a projection of the 3D digital model in the 2D scene;
generating and superimposing a 2D digital canvas onto at least a part of the 3D viewing area of the 2D scene including the first 3D digital model;
generating, based on a received user input to the graphical user interface, one or more alterations of the 2D scene or the 3D digital model, wherein the one or more alterations comprises one or more of:
a change in a position of the at least one user interaction element in the 2D scene;
a change in size of the 2D scene;
a change in arrangement of the 3D digital model in the view area;
updating the arrangement of the 3D digital model in the view area based on one or more of the alterations, wherein each update generates a change parameter, and
calculating a 2D transformation, wherein the 2D transformation comprises at least one change parameter acquired from the updated arrangement, and
applying the 2D transformation to one or more illustrative user inputs on the 2D digital canvas.

2. The method according to claim 1, wherein in response to the user input through the graphical user interface,
executing a change in position, rotation, zoom or size of the 3D digital model; and
extracting the change parameter generated based on the execution; and
calculating simultaneously with the change in position, rotation, zoom or size of the 3D digital model the 2D transformation comprising the extracted change parameter and
applying the 2D transformation to the one or more illustrative user inputs on the 2D digital canvas.

3. The method according to claim 1, wherein the one or more illustrative user inputs is applied to the 2D digital canvas from at least one user interaction element of the graphical user interface.

4. The method according to claim 1, wherein the one or more illustrative user inputs applied to the 2D digital canvas is configured as a digital hand drawing drawn onto the 2D digital canvas from user inputs applied to at least one user interaction element.

5. The method according to claim 1, wherein the one or more illustrative user inputs are post processed by applying at least one of a regularization and smoothing operation to the one or more illustrative user inputs.

6. The method according to claim 1, wherein the one or more illustrative user input(s) applied to the 2D digital canvas are transformed onto the 3D digital model at one or more area or areas of interest of the 3D digital model as defined by a user.

7. The method according to claim 1, wherein based on a user input to the graphical user interface the method comprises:
updating the view area of the digital space by rescaling, rotating or translating the rendering of the 3D digital model; and
extracting the change parameter correlated with the rescaling, rotating or translating; and
updating the 2D transformation with the extracted change parameter and applying the updated 2D transformation to the illustrative user inputs to follow the change to the rendering of the 3D digital model.

8. The method according to claim 1, wherein the method comprising
storing in a storage medium, the illustrative user inputs applied to the 2D digital canvas to a plurality of different views of the 3D digital model at which the illustrative user input is applied.

9. The method according to claim 1, wherein the method comprises
loading from a storage medium a previously stored illustrative user input associated with a 3D digital model taken at a previous point in time;
rendering the 3D digital model in the digital space from a stored camera position; and
superimposing the stored illustrative user input onto the 3D digital model.

10. The method according to claim 1, wherein the graphical user interface further comprises a view management window comprising a plurality of camera positions representing the view position of the rendering of the 3D model, wherein the method comprises:
receiving a user interaction causing activation of one of the plurality of camera positions;
executing a rendering of the 3D digital model in the view area from the chosen camera position; and
loading from the storage media one or more camera position associated 2D digital canvas comprising stored illustrative user inputs into the view area at the position of 3D model, where the illustrative user inputs have previously been stored.

11. The method according to claim 1, comprising:
receiving a first user input to the view management window, wherein the user input represents an activation of a first of the one or more camara positions,
tracking a change from a first input to a second input to the view management window, wherein the second input represents an activation of a second of the one or more camera positions;
activating an updated rendering of the 3D model in the view area based on the tracked change, where the update comprises:
updating the rendering from the first camera position to the second camera position;
loading from the storage media a stored 2D digital canvas associated with the second camera position into the view area of the 3D model wherein the illustrative user inputs have previously been stored.

12. The method according to claim 7, wherein extracting the change parameter comprising:
extracting from the illustrative user inputs on the 2D digital canvas depth values associated with each point of the illustrative user input, wherein the depth values represents a relation between the points of the illustrative user input of the 2D digital canvas and the 3D digital model to which the points have been applied;
calculating a perspective projection transformation matrix using the depth values and the scaling, rotation or translation associated with the 3D model changes; and
applying a inverse perspective projection transformation matrix to the 2D points forming the illustrative user inputs.

13. The method according to claim 1, wherein the user input is configured to cause a change in a window size of the 2D scene, wherein updating the 2D scene comprises
updating the view area by translating and scaling the 3D model rendering of the view area in accordance with the change in window size
calculating a change in center position of the 3D digital model based on the translation and scaling; and
applying the calculated change to the illustrative user inputs of the 2D digital canvas so as to transform the 2D digital canvas into the changed position of the 3D digital model in the digital space.

14. A computer readable medium configured to store instructions that, when executed by a computer, cause the computer to perform a method of rendering interactive digital three-dimensional dental models of a patient into a graphical user interface, the method comprising:
generating in the graphical user interface a digital space configured as a 2D scene and comprising at least one user interaction element;
rendering in a 3D viewing area of the 2D scene at least a first 3D digital model comprising dental information of a patient, wherein the rendering is configured as a projection of the 3D digital model in the 2D scene;
generating and superimposing a 2D digital canvas onto at least a part of the 3D viewing area of the 2D scene including the first 3D digital model;
generating based on a received user input to the graphical user interface, one or more alterations of the 2D scene or the 3D digital model, wherein the one or more alterations comprises one or more of:
a change in position of the at least one user interaction element in the 2D scene;
a change in size of the 2D scene;
a change in arrangement of the 3D digital model in the view area;
updating the arrangement of the 3D digital model in the view area based on one or more of the alterations, wherein each update generates a change parameter, and;
calculating a 2D transformation, wherein the 2D transformation comprises at least one change parameter acquired from the updated arrangement; and
applying the 2D transformation to one or more illustrative user inputs on the 2D digital canvas.
